(19) United States
(12) Patent Application Publication
(10) Pub. No.: US 2012/0152809 A1
(43) Pub. Date: Jun. 21, 2012

(54) Methods and Apparatus for Bitumen Extraction

(75) Inventors: Julian Kift, Reno, NV (US); Mahendra Joshi, Katy, TX (US); Cherish M. Hoffman, Reno, NV (US); Whip C. Thompson, Reno, NV (US); Dominic J. Zelnik, Sparks, NV (US)

(73) Assignee: MARATHON OIL CANADA CORPORATION, Calgary (CA)

(21) Appl. No.: 13/306,733

(22) Filed: Nov. 29, 2011

Related U.S. Application Data
(60) Provisional application No. 61/417,748, filed on Nov. 29, 2010.
(60) Provisional application No. 61/526,384, filed on Aug. 23, 2011.

(51) Int. Cl. C10G 1/04; B01D 11/02

(52) U.S. Cl. 208/390; 196/14.52

(57) ABSTRACT

Methods and system for extracting bitumen can include the use of a mixing drum for spraying solvent over bituminous material to help dissolve bitumen and create a bitumen-laden solvent phase that can be separated from the non-bituminous components of the bituminous material. The mixing drum can be rotating during the spraying step to help promote dissolution of bitumen. The mixing drum can also include an internal screen for separating bitumen-laden solvent from the non-bituminous material. In some embodiments, two or more mixing drums are used in series, with the non-bituminous material from the first mixing drum being sprayed with additional solvent in the second mixing drum and bitumen laden solvent from the second mixing drum being used as the solvent sprayed over bituminous material in the first mixing drum. Hydrocyclones can also be incorporated in the in system and methods for increased extraction efficiency.

This application claims priority to U.S. Provisional Application No. 61/417,748 filed Nov. 29, 2010 and U.S. Provisional Application No. 61/526,384, filed Aug. 23, 2011, each of which is hereby incorporated by reference in its entirety.

### BACKGROUND

Bituminous material such as oil sands typically include sand, clay, water, and heavy crude oil. Many countries in the world have large deposits of oil sands, including the United States, Russia, and various countries in the Middle East. However, three quarters of the world's reserves are found in Venezuela and Canada. Oil sands may represent as much as two thirds of the world's total petroleum resource, but are difficult to develop because of the expense associated with recovering oil from oil sands.

Bitumen extraction from bituminous material such as oil sand can be a very energy intensive process. In the extraction of bitumen from bituminous material, the bituminous material is typically mined, usually by a bucket wheel excavator of dragline, and is then subjected to hot water extraction processing. In a typical hot water extraction process, the bituminous material is mixed with hot water so that the bitumen content of the bituminous material floats as a froth and the solid matter content of the bituminous material sinks, making it possible to skim off the froth for further separation and eventual refining into finished products.

In some conventional hot water extraction processes, 87% by weight of bitumen and diluent naphtha are recovered from the bituminous material, with the remaining 13% by weight being disposed of in the tailings stream. Disposal of the tailings involves passing it to a tailings pond. The waste hot water in the tailings can be at a temperature of approximately 185° F. to 195° F. The disposal of this hot water to a tailings pond considerably reduces the overall plant thermodynamic efficiency, as the heat loss must be made up when heating additional cold water used for subsequent hot water extraction processing.

In addition, the tailings can be sluiced into retaining areas, such as large ponds formed from darns or dykes built from tailings. When a first pond is filled, a second dam is often built in the middle of the mined out area and this process of building dams and filling the ponds formed between the dams is continued until the reserve of mineable oil sands has been depleted. Eventually, it is common for most of the area of the mined out acreage to be covered by the tailings ponds. Environmental authorities have determined that there has been and will continue to be significant resulting pollution of the underground water streams, surrounding lakes, and other fresh water bodies adjacent to the mining areas and their tailings ponds. Under this tailings disposal system, usually little, if any, of the mined out land can be reclaimed and put to useable form.

### BRIEF SUMMARY

Applicants have invented an improved apparatus and methods for bitumen extraction. In some embodiments, the bitumen extraction method includes (a) feeding a first quantity of bituminous material into a mixing drum, (b) spraying first solvent over the first quantity of bituminous material inside the mixing drum and forming a slurry, (c) separating coarse solids from the slurry and removing the slurry from the mixing drum, (d) separating the slurry into a first disbit stream and a first tailings stream, (e) feeding the first tailings stream into the mixing drum, (f) spraying second solvent over the first tailings stream inside the mixing drum, (g) removing the first tailings stream from the mixing drum, and (h) separating the first tailings stream into a second disbit stream and a second tailings stream. In some embodiments, the use of the mixing drum in the extraction process improves dissolution of bitumen into the solvent and increases bitumen extraction efficiency beyond other previously used methods. When the mixing drum is rotated at greater than 30% of the critical rotation speed during the spraying of the solvent, the method can provide a significantly improved manner for accessing bitumen material and dissolving the bitumen in the solvent. Additionally, the use of blends of aromatic and paraffinic solvent can provide desirable dissolution of bitumen while preventing undesirable asphaltene precipitation.

In some embodiments, a bitumen extraction system includes: a first mixing drum having a first solvent inlet, a first disbit outlet, and a first tailings outlet; a first separation unit having a second disbit inlet in fluid communication with the first disbit outlet, a cleaned disbit outlet, and a solid materials outlet; and a second mixing drum having a first tailings inlet in fluid communication with the first tailings outlet of the first mixing drum, a second disbit outlet in fluid communication with the first solvent inlet of the first mixing drum, and a second tailings outlet. The mixing drums in the system allow for improved dissolution of bitumen in bituminous material and in some embodiments can provide for improved bitumen extraction efficiency. By using a rotational speed of greater than 30% of the critical rotational speed, the mixing drums in the system can allow for the solvent to access and dissolve greater amounts of bitumen. The use of a mixture of aromatic and paraffinic solvent in the system described can also provide the benefit of desired bitumen extraction in the mixing drums while not precipitating asphaltenes that can interfere with other parts of the system.

In at least one or more embodiments, novel features and/or advantages of the method can variously include one or more of the following: use of a mixing drum to add solvent to bituminous material, recover disbit, and remove tailings; use of multiple mixing drums in counterflow configuration, which in some embodiments can increase extraction efficiency; use of one or more hydrocyclones to carry out bitumen extraction, which in some embodiments can increase extraction efficiency; reducing or eliminating the need for hot water in bitumen extraction processing; reducing or eliminating tailings ponds containing oil emulsions and unstable clay fine gels; improving the thermodynamic efficiency of the bitumen extraction process; and improving the bitumen recovery efficiency up to more than 90%.

There are other novel features and advantages of various embodiments disclosed herein. They will become apparent as this specification proceeds. In this regard, it is to be understood that scope of the invention is to be determined by the claims as issued and not by whether they address issues noted in the Background or provide aspects set forth in this Brief Summary.

### BRIEF DESCRIPTION OF THE DRAWINGS

The preferred and other embodiments are disclosed in association with the accompanying drawings in which:

FIG. 1 is a flow chart detailing a common component shared by some of the various bitumen extraction methods described herein wherein solvent is sprayed over bituminous material in a mixing drum to dissolve bitumen and provide a bitumen-laden solvent component that can be separated from the non-bituminous components;

FIG. 2 is a process flow diagram for some embodiments of a method for extracting bitumen from bituminous material described herein and wherein basic structure of a mixing drum suitable for use in the various embodiments is shown, including a spray bar extending into the mixing drum and a screen liner for separating components within the mixing drum;

FIG. 3 is a flow chart detailing some embodiments of a method for extracting bitumen from bituminous material described herein wherein two mixing drum so that bitumen extraction can be performed on both the bituminous material and the tailings and bitumen extraction efficiency can thereby be improved;

FIG. 4 is a process flow diagram detailing some embodiments of a method for extracting bitumen from bituminous material in which two mixing drums aligned in series are used so that bitumen can be extracted from both bituminous material and tailings and bitumen extraction efficiency can be increased;

FIG. 5 is a process flow diagram detailing some embodiments of a method for extracting bitumen from bituminous material as disclosed herein wherein a hydrocyclone is used in conjunction with a mixing drum to improve separation of the slurry produced in the mixing drum;

FIG. 6 is a process flow diagram detailing some embodiments of a method for extracting bitumen from bituminous material as disclosed herein wherein multiple: hydrocyclones aligned in series are used in conjunction with the mixing drum to improve separation of the slurry produced in the mixing drum;

FIG. 7 is a process flow diagram detailing some embodiments of a method for separating the tailings produced in the mixing drum using numerous hydrocyclones aligned in series;

FIG. 8 is a flow chart detailing various embodiments of a method for extracting bitumen from bituminous material as disclosed herein wherein the tailings produced by the bitumen extraction occurring in the mixing drums are treated in a column with additional solvent to extract additional amounts of residual bitumen and increase bitumen extraction efficiency of the overall system; and

FIG. 9 is a process flow diagram detailing various embodiments of a method for extracting bitumen from bituminous material as disclosed herein that uses a crushing apparatus for preparing the bituminous material for bitumen extraction, mixing drums for dissolving bitumen from bituminous material, thickeners for separating product streams produced by the mixing drums, and a packed column for extracting residual bitumen from the tailings.

### DETAILED DESCRIPTION

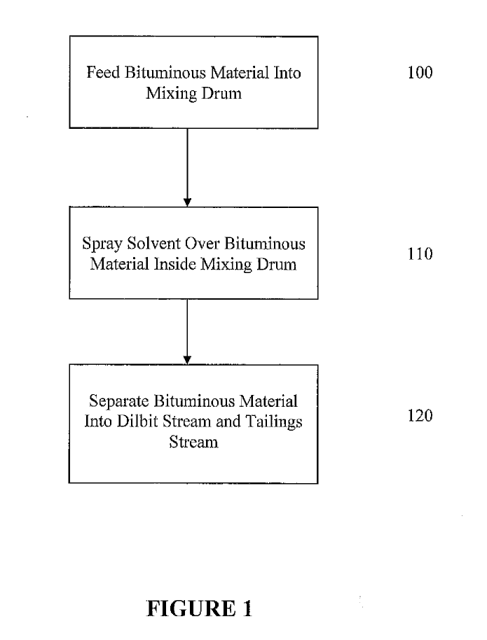

With reference to FIG. 1, a bitumen extraction method according to some embodiments disclosed in this specification includes a step 100 of feeding bituminous material into a mixing drum, a step 110 of spraying solvent over the bituminous material inside the mixing drum, and a step 120 of separating the bituminous material into a disbit stream and a tailings stream.

The mixing drum used in step 100 can generally include any type of drum suitable for use in mixing together bituminous material and solvent. In some embodiments, the mixing drum is an enclosed drum that includes one or more inlets for feeding bituminous material and solvent into the drum and one or more outlets for removing various materials from the mixing drum. The various inlets and outlets in the mixing drum can be located throughout the mixing drum. The material of the mixing drum is not limited, and may include materials that are generally impermeable and corrosion resistant. In some embodiments, the mixing drum has a generally cylindrical shape, although other shapes may be used. The mixing drum can also vary in size and dimensions, and the size and dimensions of the drum are generally selected based on the amount of bituminous material to be handled inside the mixing drum.

In some embodiments, the mixing drum is a cylindrically-shaped drum oriented such that the axis of the Cylindrically-shaped drum is generally horizontal. The cylindrically-shaped drum can also be slanted such that one end is higher than the other, or positioned in a generally vertical position. However for purposes of this discussion, the drum will be described in the scenario where the axis of the drum is generally horizontal.

The cylindrical drum can include one or more inlets located at various locations throughout the drum for feeding bituminous material inside of the drum. In some embodiments, the inlets are located proximate one end of the drum for the introduction of bituminous material into the drum. The inlets can be located around the circumference of the drum near one end of the drum, in the end wall of the drum (i.e., the wall perpendicular to the ground when the axis of the drum is positioned horizontally), or a combination of both.

The drum can also include inlets for providing solvent to the interior of the drum, The inlets for adding solvent into the drum can be located anywhere about the drum, such as those locations described above with respect to inlets for feeding bituminous material inside of the drum. In some embodiments, inlets are provided at various locations throughout the drum such that solvent can be added into the drum at various locations throughout the drum.

In some embodiments, the various inlets and outlets included in the mixing drum can be sealed when mixing occurs within the mixing drum. Sealing of the inlets and outlet can help to ensure that materials inside the mixing drum do not leak out of the mixing drum, and also that any gases or vapors produced inside of the mixing drum do not leak out of the mixing drum.

In some embodiments, one or more spray bars are positioned within the drum to provide solvent to the interior of the drum. In such embodiments, the spray bar passes through an end wall of the drum and solvent enters the interior of the drum by passing through the spray bar and into the drum. The spray bar can include numerous nozzles along its length where solvent is sprayed into the interior of the drum. In some embodiments, the spray bar is oriented generally parallel to the axis of the cylindrical drum, although other orientations can be used.

In some embodiments, the interior walls of the mixing drum include a liner that protects the shell of the mixing drum. This liner can cover the entirety of the interior wall of the mixing drum or only portions of the interior of the mixing drum. Any suitable liner material can be used, and in some embodiments, the liner material is alloy steel or a thick layer of rubber or any other elastomer that is compatible with the selected solvent. This liner material prevents wear to the mixing drum. Any manner of securing the liner to the interior walls of the mixing drum can be used, and in some embodiments, the liners are bolted securely to the mixing drums with specially designed washers that prevent drum leakage.

The cylindrical drum can also include a mechanism for rotating the drum, including rotating the drum about its axis. Any manner of rotating the drum can be used, including hydraulic motors and tire and trunnion mechanisms. The speed at which the drum can be rotated can vary over a wide range of speeds.

The cylindrical drum can also include a screen liner for facilitating the separation of materials inside the drum. The screen liner can have any suitable shape, including a generally cylindrical shape. When the screen liner has a cylindrical shape, the diameter of the screen liner can be smaller than the diameter of the mixing drum such that the screen liner is positioned inside of and coaxial with the mixing drum. In some embodiments, the screen liner can include a plurality of coaxially aligned screens, with each screen having a different mesh size. In this manner, the multiple screen liner can effect a coarse and fine separation of materials inside the mixing drum.

The screen liner can extend along the entire length of the drum or only a portion of the length of the drum. In some embodiments, the screen liner is located at only one end of the drum, and preferably the end of the drum opposite inlets for introducing bituminous material into the drum. In some embodiments, the screen liner has a length that is more than half the length of the mixing drum. For example, the mixing drum can have an overall length of 22 meters, with the screen liner having a length of 12 meters. In such a configuration, mixing occurs in the mixing drum along the first 10 meters of the mixing drum, and separation occurs along the last 12 meters of the mixing drum. In this manner, mixing between bituminous material and solvent can take place along a first portion of the length of the drum while separation occurs at the end of the drum, after substantial mixing has taken place.

The mesh size of the screen liner can vary and be adjusted depending on the sizes of the material to be separated. In application, the screen effectively creates an area between the liner and the drum where material that passes through the liner can collect and be removed from the drum via a first outlet, and an area within the screen liner where coarse non-bituminous material (i.e., rocks, clay lumps, etc.) remains. The material that cannot pass through the liner remains within this inner area can be removed from the drum via a second (i.e., rejects) outlet. The first outlet is therefore positioned along the drum in a position that communicates with the area between the liner and the drum. In some embodiments, this location will be along the circumference of the drum. Similarly, the second outlet can be positioned at a location that is in communication with the interior of the screen liner. In some embodiments, this location will be on an end wall of the drum. In some embodiments, the mesh size of the screen liner is from between 150 mm and 10 mm.

The cylindrical drum can further include lifting shelves (i.e., lifters) that help to promote mixing within the drum when the drum rotates. The height of each lifting shelf generally extends radially inward from the interior wall of the mixing drum, while the length of each lifting shelf is generally oriented parallel to the axis of the drum. In this manner, the lifting shelves carry a portion of the material inside of the drum up along the wall of the drum as the drum rotates. Eventually the lifting shelves rotate to a position where they slant downwardly and the lifted material falls back down towards the bottom of the drum. This movement of the material helps to promote mixing as discussed in greater detail below. The lifting shelves can be made from any suitable material, including steel, rubber, or other elastomers compatible with the solvents in use. Each lifting shelf can have a length that extends the entire length of the drum or the lifting shelves can lengths that are shorter than the length of the drum. When in shorter segments, various lifting shelves along the length of the drum can be offset from other lifting shelves located at other positions along the length of the drum.

The height of each lifting shelf can be any suitable height and the heights of the lifting shelves can be the same or varying throughout the drum. In some embodiments, the placement and height of each lifting shelf can be adjusted in order to vary the residence time of the material inside of the drum. Longer residence times can lead to more mixing, and therefore adjustments can be made to the placement and height of the lifting shelves used in order to increase or decrease residence time. In some embodiments, the lifting shelves can be in the form a flute, such as commonly used in a cement mixer, to gently knead and mix the slurry without creating high shear.

Retention rings may also be included within the drum to further vary residence time. One or more retention rings can be placed axially along the length of the drum and will slow the movement of material from one end of the drum to the other, thereby increasing residence time and promoting further mixing between materials.

In some embodiments, the mixing drum may also include a heating mechanism for heating the material inside of the mixing drum. Any suitable type of heater can be used to accomplish the heating of material inside the mixing drum. In some embodiments, the mixing drum includes direct or indirect heating via, for example, a hot water or steam jacket surrounding a portion or all of the exterior of the mixing drum to thereby provide heat from the hot water or steam passing through the jacket through the walls of the mixing drum and to the material inside of the mixing drum. Use of a heater with the mixing drum can be especially preferable when the materials inside of the mixing drum are cold when transported into the mixing drum. For example, when the bituminous material transported into the mixing drum is mined Alberta oil sands, the temperature of the bituminous material is very cold. In some embodiments, the heater used in conjunction with the mixing drum is capable of heating the materials inside of the mixing drum to a temperature between 20° C. and 60° C.

In some embodiments, the mixing drum is a trommel or a pulper. Trommels or pulpers generally include the closed drum configuration used for the mixing drum and can further include the internal screen mechanism for separating various materials inside of the drum. Any trommel or pulper suitable for use in mixing together and separating different materials can be used.

The bituminous material fed into the mixing drum can include any material that includes a bitumen content. In some embodiments, the bituminous material is oil sands or tar sands. The source of bituminous material is also not limited, and can include bituminous material obtained from natural deposits (such as by mining) or material that is produced by other processes (such as distillation bottoms produced by a distillation column). The bitumen content of the bituminous material can vary across a wide range and is generally dictated by the quality of the bituminous material being processed. For example, high quality bituminous material can include greater than 20% by weight bitumen, while lower quality bituminous material can include less than 5% by weight bitumen. Other components of the bituminous material can include, but is not limited to, water, clay, and sand.

Any suitable manner for feeding the bituminous material into the mixing drum can be used. As mentioned above, the bituminous material can be fed into the mixing drum through one or more inlets located at various locations throughout the mixing drum. The bituminous material can be transported to the mixing drum inlet by any manner, including through the use of conveyor belts, chutes, hoppers, and screw feeders. In some embodiments, the bituminous material is transported into the mixing drum as the mixing drum is rotating about its axis.

In some embodiments, the bituminous material may be broken into smaller pieces prior to introduction into the mixing drum. Any manner of breaking up the large pieces of bituminous material may be used, including the use of a traditional breaker, sizer, or crusher. In some embodiments, the bituminous material is broken up into pieces having a size of less than 3 inches or, in some cases, less than 1 inch.

In some embodiments, solvent is mixed with the bituminous material prior to and/or during the process of breaking up larger pieces of bituminous material into smaller pieces. The solvent used during the breaking/crushing step can be the same solvent used in subsequent solvent bitumen extraction steps and described in greater detail below. In some embodiments, the first solvent mixed with the bituminous material prior to and/or during the crushing process is a solvent with sufficient aromatic content to maintain the asphaltenes in solution at the chosen S:B ratio, which can include a specifically blended mixture of aromatic solvent and paraffinic solvent or a marketed solvent (Natural Gas condensate) or blend with the correct aromatic content. The solvent used in the breaking/crushing step can be heated, such as to within a range of from 50° F. to 100° F.

Adding solvent to the bituminous material as part of the crushing step can be carried out in any suitable manner that wets the bituminous material with solvent and begins the process of dissolving bitumen in the solvent. In some embodiments, the solvent is sprayed over the bituminous material prior to or as the bituminous material enters the crushing apparatus or while the bituminous material is in the crushing apparatus. For example, a crushing apparatus can be configured with one or more spray nozzles for spraying solvent over the bituminous material before and/or as the bituminous material passes through the crushing mechanism (e.g., a crushing roller). In other embodiments, the solvent and the bituminous material can be mixed together to form solvent-wet bituminous material prior to being introduced into a crushing apparatus. In other words, a mixing vessel separate from the crushing apparatus can be provided that prepares the solvent-wet bituminous material prior to introducing the bituminous material into the crushing apparatus. Any suitable mixing vessel, including a mixing vessel having mixing blades, can be used. Adding solvent to the bituminous material can also be carried out on the conveyors, buckets, or chutes used to transport the bituminous material to the crushing apparatus.

Any suitable amount of solvent can be added to the bituminous material. In some embodiments, the amount of solvent added to the bituminous material is from 0.5 to 4 times the amount of bitumen in the bituminous material on a v/v basis.

The solvent-wet bituminous material is subsequently crushed in order to reduce the size of clumps of bituminous material and assist with further mixing between the solvent and the bituminous material. Any manner of crushing the solvent-wet bituminous material can be used, including the use of crushing apparatus known to those of ordinary skill in the art. Exemplary crushing mechanisms include, but are not limited to, crushing rollers or sizers.

In some embodiments, the solvent-wet bituminous material is crushed by passing the solvent-wet bituminous material through crushing rollers. The crushing rollers can be individually driven by electrical motors, gear motors, or with coupling and gears counter rotating via V-belts. Even distribution of the solvent-wet bituminous material across the entire length of the crushing rollers or other crushing mechanisms, the use of a favorable angle of entry, and in the case of crusher rollers, adjusting the speed and diameter of the crusher rollers, can help to ensure efficient crushing of the solvent-wet bituminous material and reduced wear and tear on the crushing mechanism.

Crushing rollers used to crush the solvent-wet bituminous material can also be internally heated to help improve disaggregation. Any suitable manner of internally heating the crushing rollers can be used, such as through the use of steam, hot water, or electricity. The crusher rollers can be heated to any suitable temperature for improving disaggregation. In some embodiments, the crusher rollers are heated to a temperature below the boiling point temperature of the solvent, such as from 50° F. to 100° F.

In some embodiments, the crusher rollers are provided with perforations or holes that deliver solvent to the surface of the crusher rollers. Providing solvent in this manner can create a wet film on the surface of the crusher rollers that further reduced mechanical wear and tear on the surface of the crusher rollers. The solvent delivered through these holes can be heated and can be delivered to the surface of the crusher rollers continuously or intermittently.

In some embodiments, conveyors can be used to deliver bituminous material into the crushing apparatus. In instances where the bituminous material is wetted with solvent prior to being introduced into the crushing apparatus, the conveyors can be used to deliver solvent-wet bituminous material into the crushing apparatus. In instances where the mechanism for adding solvent to the bituminous material is incorporated into the crushing apparatus (e.g., spray nozzles located within the crushing apparatus and upstream of the crushing mechanism), the conveyors can be used to deliver dry bituminous material into the crushing apparatus.

In some embodiments, the steps of adding solvent to the bituminous material and crushing the solvent-wet bituminous material are repeated. Additional solvent can be added to the crushed solvent-wet bituminous material produced by the first solvent addition step and the first crushing step, followed by subjecting the crushed solvent-wet bituminous material to a second crushing step. Following the one or more wetting and crushing steps, the bituminous material can be fed into the mixing drum.

In some embodiments, the bituminous material is deoxygenated prior to being introduced into the mixing drum. Deoxygenation generally removes a portion of the free oxygen from the interstitial spaces in the bituminous material and can be carried out to make solvent-based bituminous material processing described herein safe. Deoxygenation prepares the bituminous material for entry into a hydrocarbon or solvent environment.

Any suitable process for deoxygenation can be used. In some embodiments, deoxygenation is performed in a deoxygenating unit. Bituminous material that has been subjected to crushing (such as to a size of less than 6 inches) is passed into a deoxygenation unit. An inert gas, such as N₂, is passed up through the bituminous material in the deoxygenation unit to displace free oxygen from the interstitial spaces of the bituminous material. The interstitial spaces become occupied by the inert gas and the displaced oxygen is vented from the top of the deoxygenation unit. The inert gas continuously flows into the deoxygenation unit in order to maintain the oxygen level below the desired amount. In some embodiments, the oxygen level inside the deoxygenation unit is maintained at below the Lower Explosive Limit (LEL) for the solvent used, typically 5% or less oxygen for the paraffinic solvents used.

Once the deoxygenation has taken place, the bituminous material can be transported into the mixing drum. Steps can be taken to ensure the bituminous material maintains the low oxygen level during transport. In some embodiments, a seal is provided to separate oxygen rich environments from solvent rich environments. Exemplary seals include water seals or pressure lock valves. It may also be desirable to provide a low pressure barrier against hydrocarbon backflow and sealing with acceptable fugitive emission limits.

In some embodiments, a screening step is performed on the bituminous material prior to feeding the bituminous material into the mixing drum. The screening step can be carried out in order to remove, for example, large lumps of clay, waste rock, petrified wood, and other solid debris from the bituminous material. In some embodiments, the screening step is designed in order to reject material in the bituminous material having a size larger than 150 mm. Any technique suitable for use in removing large pieces of material from the bituminous material can be used, including passing the bituminous material through a screen material having a predetermined mesh size.

The screening step can be carried out before, after, or both before and after the crushing step described above. In embodiments where the screening is carried out after a crushing step that uses solvent (or in any scenario where the bituminous material being screened includes a solvent content), the material screened out of the bituminous material can be processed in order to recover solvent from and dry the reject material. Any technique suitable for removing solvent from a reject stream can be used, including evaporating the solvent from the reject material and collecting and condensing the evaporated solvent. Alternatively, the reject material can be subjected to further crushing and re-introduced to the mixing drum or at a downstream part of the process.

Once bituminous material has been fed into the mixing drum, a step of 110 of spraying a solvent over the bituminous material inside the mixing drum takes place. The solvent wets the bituminous material and forms a slurry of material inside the mixing drum. One aim of adding solvent to the bituminous material inside of the drum is to promote the dissolution of bitumen into the solvent to thereby extract it from the bituminous material. The rotating mixing drum, lifting shelves, retention rings, heat and other mechanisms can be used to promote the mixing between the bituminous material and the solvent and the dissolution of the bitumen in the solvent. Eventually, a phase of bitumen dissolved in solvent, also referred to as “disbit,” and a phase of bitumen-depleted tailings will result from the mixing of solvent and bituminous material inside of the mixing drum.

Any solvent capable of dissolving all or a specific part of the bitumen can be sprayed over the bituminous material inside of the mixing drum. Exemplary solvent suitable for use in step 110 include aromatic solvents, paraffinic solvents (such as propane and pentane), naphtha, bio-diesel, methanol, and ethanol. In some embodiments, the solvent is primarily aromatic solvent. Suitable aromatic solvents include, but are not limited to, benzene, toluene, and commercial solvents such Solvesso 100, Solvesso 150, and Solvesso 200. In some embodiments, the solvent is “disbit,” i.e., bitumen dissolved in a solvent. Any of the solvents mentioned above may serve as the solvent component in the “disbit.” In some embodiments where “disbit” is used as the solvent sprayed over the bituminous material, the “disbit” is from about 40% to about 80% solvent by volume.

In some preferred embodiments, the solvent is a mixture of aromatic and paraffinic solvent. The ratio of aromatic solvent to paraffinic solvent is generally not limited, although a sufficient amount of aromatic solvent to maintain the asphaltene in solution at the chosen S:B ratio is generally provided. In some embodiments, the solvent mixture includes from 20 to 25% aromatic solvent and the remainder paraffinic solvent. In some embodiments, natural gas condensate will include aromatic solvent and paraffinic solvent in the desired ratio and therefore can be used as the solvent for the methods described herein.

Using a blend of aromatic and paraffinic solvent as described above can provide several advantages and benefits. The relatively small amount of aromatic solvent can provide for full bitumen recovery without releasing fines, while the relatively larger amount of paraffinic solvent beneficially lowers the viscosity of the disbit product. As a result, the use of a blend of aromatic and paraffinic solvent for the dissolution of bitumen can recover 95% or greater of the bitumen in the bituminous material with very little asphaltene precipitation into the tailings. The precipitation of asphaltenes can be controlled by a) the aromatic content and b) the S:B ratio and as such a minimal amount of asphaltenes can be specifically rejected to the tailings. This minimal amount of asphaltene rejection is desired to reduce the sediment content of the bitumen product as the asphaltene precipitates are known to agglomerate the fine solids and in this way the blend of solvents can ultimately provide a market quality bitumen product. Bitumen product considered to be of “market quality” can vary based on a variety of factors, including based on source and market. Exemplary but non-limiting characteristics of market quality bitumen product derived from Canadian Athabasca oil sands are listed in Table 1.

TABLE 1

| | |
|---|---|
| Density (kg/m³) | 935 |
| Sulphur (wt %) | 43-6 |
| Micro Carbon Residue (wt %) | <11 |
| Sediment (ppmw) | 200 to 800 |
| Total Acid Number (mgKOH/g) | <1.5 |
| Salt (ptb) | 30 |
| Viscosity @ Pipeline T (cSt) | 350 |
| Bottom Sediment &Water (vol %) | <0.5 |
| Vapor Pressure (kPa @ 37.8° C.) | 76 |
| P-value | >1.1 |
| Fouling (% at 400° C.) | 20 |
| Desalting Performance | No Stable Emulsion Formation |

In some embodiments, the amount of solvent sprayed over the bituminous material is based on a ratio of solvent to bitumen content in the bituminous material. Accordingly, the amount of solvent used can vary based on the quality of the bituminous material (i.e., the bitumen content of the bituminous material and the pore size in the bitumen). In some embodiments, the solvent to bitumen ratio (S:B) used in the spraying step 110 is from about 0.5:1 to 4:1 on a volume basis. Using a solvent to bitumen ratio within this range can help to ensure that enough solvent is sprayed over the bituminous material to dissolve a substantial portion of the bitumen content of the bituminous material. In some embodiments, the solvent can already have a bitumen content itself (recycle solvent) and where the solvent is a mixture of aromatic solvent and paraffinic solvent, the S:B ratio of the recycle solvent can be in the range of from 1.5 to 2.5. The use of recycle solvent is advantageous in creating slurry with enough liquid volume (e.g., for pumping), but still maintaining a low S:B ratio.

When spraying solvent into the mixing drum containing bituminous material therein, a volume of the mixing drum will be occupied by the resulting slurry. In some embodiments, the amount of bituminous material and solvent into the mixing drum at one time is controlled in order to ensure that no greater than or no less than a specified percentage of the internal volume mixing drum is occupied. Over or under filling the mixing drum can negatively impact the mixing of the solvent and bituminous material and the dissolution of bitumen into the solvent. In some embodiments, from 20% to 60% of the volume inside the mixing drum is occupied by bituminous material and solvent.

As described above, the effect of spraying the solvent over the bituminous material is to create a slurry of material inside the mixing drum that can include two phases. The first phase is bitumen dissolved in solvent (“disbit”). The second phase is bitumen-depleted tailings. The bitumen-depleted tailings will generally include solvent, water, sand, clay, and a relatively small amount of bitumen that was not dissolved by the solvent. Some or all of the bitumen content of the bitumen-depleted tailings can include bitumen that is occluded on the inert material of the tailings. While the rotation of the mixing drum can work to remove some of the bitumen that is stuck to the inert material (e.g., due to contact between slurry falling from the lifting shelves with slurry residing at the bottom of the mixing drum), the rotation of the drum typically does not remove all of the occluded bitumen from the inert material. Accordingly, a relatively small amount of bitumen remains with the bitumen-depleted tailings.

The rotation of the drum while the solvent is sprayed over the bituminous material can be any suitable speed that helps to promote mixing of the solvent and the bituminous mater and create disbit. In some embodiments, the rotational speed is kept relatively slow in order to avoid the dispersion of the clay component of the bituminous material. High rotational speeds cause clay dispersion because of high agitation and attrition breaking up clay lenses. Clay dispersion is undesirable because clays can become suspended in the disbit and affect disbit quality, requiring additional clay removal steps. In some embodiments, the rotational speed of the mixing drum is kept to less than 10 rpm in order to avoid clay dispersion, although higher rotational speeds can be used.

In some embodiments, the rotational speed of the mixing drum is based on a percentage of the critical rotational speed N_{c}. The critical rotation speed is defined according to equation (1):

Nc=42.3/4/√D (1)

where D is the diameter of the mixing vessel expressed in meters. At the critical rotational speed, the centrifugal forces take over the physical process inside the mixing drum and liquid begins to fly out to the inner diameter of the mixing drum, thus making the mixing drum dysfunctional. In some embodiments, the mixing drum is operated at a minimum of 30% of the critical rotational speed. Generally speaking, up to an optimum higher rotation speeds lead to quicker dissolution rates due to the increased mixing efficiency between the solvent and the dissolved bitumen and the diffusion interface and better lump break down efficiency.

In some embodiments, the rotation of the mixing drum continues after spraying solvent over the bituminous material inside the mixing drum has ceased. Continuing to rotate the mixing drum during and after the solvent is sprayed over the bituminous material inside the mixing drum promotes mixing of the slurry of bituminous material and solvent and the dissolution of the bitumen content of the bituminous material into the solvent as described above. In some embodiments, the mixing of the slurry by the continued rotation of the mixing drum during and after solvent is sprayed over the bituminous material can continue for a period of time sufficient to ensure that bitumen dissolution occurs and a disbit phase is created. The specific period of time of mixing can vary based on varying factors, including the bitumen content of the bituminous material and the amount of solvent sprayed over the bituminous material.

The injection of solvent into the mixing drum and the subsequent mixing of the solvent and the bituminous material to create disbit can, in some embodiments, create a need for the mixing drum to include a solvent vapor recovery system. A solvent recovery system can be necessary due to the volatility of some of the solvents suitable for use in the methods described herein. Despite being injected into the mixing drum as a liquid, portions of such volatile solvents may convert to a vapor phase once inside the mixing drum, and therefore require venting from inside the mixing drum. Any solvent vapor recovery system suitable for use with a mixing drum can be used, including one or more solvent vents on the mixing drum and a solvent vapor collection vessel connected to the one or more solvent vents.

In some embodiments, the mixing drum can be a pressurized mixing drum. A pressurized mixing drum may be necessary in instances where the solvent injected into the mixing drum will not remain in a liquid state unless the mixing drum is pressurized. For example, the mixing drum can be a pressurized mixing drum when propane or butane is used in order to keep the propane and/or butane in a liquid state inside the mixing drum. Any mechanism suitable for pressurizing the mixing drum can be used.

The period of time during which the bituminous material and the solvent are retained with the mixing drum is generally not limited. The retention time is generally selected to maximize dissolution. However, in batch testing the percent of bitumen dissolved as a function of retention time begins to flatten out after a certain period of time. In some embodiments, the retention time is in the range of approximately 7 minutes, at which point roughly 90% of the bitumen is dissolved. After 7 minutes, minimal additional dissolution is achieved. In a continuous mixing drum the dissolved material will exit the drum quicker than the slower dissolving material, resulting in an “average” retention time shorter than the 7 minutes seen in batch testing.

The mixture of bituminous material and solvent and the creation of a slurry having disbit and bitumen-depleted tailings is followed by a step 120 of separating the disbit from the slurry. Any technique capable of separating the disbit from the slurry can be used, including gravity techniques such as hydrocyclones, thickeners, or clarifiers. As mentioned above, a liner screen located within the mixing drum can be used in some embodiments. The liner screen, such as a coaxial liner screen position at one end of the mixing drum, can have a mesh size that is large enough to allow the disbit to pass through but that is small enough to keep the bitumen-depleted tailings within the liner screen. As the disbit passes through the liner screen, the disbit can be routed to an outlet in the mixing drum so that it can be removed from the mixing drum and used in subsequent steps of the process. Similarly, the bitumen-depleted tailings that remain within the liner screen can be transported out of the mixing drum via an outlet in the mixing drum. Once removed from the mixing drum, the bitumen-depleted tailings can be subjected to further processing, such as further contacting with solvent for additional bitumen recovery or solvent recovery.

Based on the mixing and separation steps, the disbit obtained from the mixing drum can typically include from about 30 to about 60 wt % bitumen and from about 40 to about 70 wt % solvent. Relatively small amounts of solid material, such as sand, may also be included in the disbit. In some embodiment, the disbit may include from about 0 to about 15 wt % solid material. With respect to the bitumen-depleted tailings resulting from the mixing and separating steps, the bitumen-depleted tailings generally include from about 70 to about 95 wt % inert materials (such as clay and sand), from about 0 to about 5 wt % water, from about 5 to about 15 wt % solvent, and from about 3 to about 10 wt % bitumen.

If undesirable solid material such as fine solids or clays remain in the disbit, additional steps can be taken to remove the solid material and form an essentially pure disbit material. Any technique that removes solid material from the disbit can be used. In some embodiments, a hydrocyclone, centrifuge, filter, polymeric membrane, or screen is used to remove the solid material from the disbit. Preferably, the hydrocyclone, centrifuge, filter, polymeric membrane, or screen removes 95% or more of the solid material in the disbit, although removal of solid material down to any level suitable for subsequent processing is also acceptable. The solid material, which will include mostly sand particles, can then be disposed of, added back with the bitumen-depleted tailings leaving the mixing drum, or be recycled back into the mixing drum in the same manner as bituminous material is fed into the mixing drum in order to attempt to recover any remaining bitumen that may be occluded on the solid material. When solid material is fed back into the mixing drum, the solid material undergoes similar or identical processing steps as those described above with respect to bituminous material.

The purified disbit obtained after solid material is removed therefrom can be subjected to a variety of further processing steps. In some embodiments, the disbit is transported to a storage tank where it can be added to other disbit already collected. In some embodiments, disbit collected in the storage tank can be used as the solvent sprayed over the bituminous material in step 110. In order to ensure that the disbit used as solvent in step 110 has a desirable bitumen and solvent content, additional solvent can be added to the storage tank or bitumen can be removed from the storage tank. For example, if the disbit contained in the storage tank includes 60 wt % solvent and 40 wt % bitumen but a 70% wt solvent and 30 wt % bitumen content is desired when the disbit is used as solvent sprayed over the bituminous material in the mixing drum, then solvent can be added to the storage tank to get the disbit in the storage tank to the correct composition. The solvent that is added to the storage tank can be any of the solvents discussed above. Any suitable manner of removing bitumen from the storage tank can be used, such as by distillation, flashing, gravity separation, and filtration with polymeric membranes.

In embodiments where the disbit is used as a solvent and sprayed over bituminous material transported into the mixing drum in step 110, the disbit can optionally be heated by a heating mechanism prior to being sprayed over the bituminous material. In some embodiments (and depending on the boiling point of the solvent), the disbit is heated to a temperature between 20° C. and 120° C. Any type of heater can be used to heat the disbit to a temperature within this range, including a heat exchanger.

In embodiments where the solvent used in step 110 is not disbit, the disbit in the storage tank can be processed to separate the bitumen from the solvent, at which point the separated solvent can be used as the solvent sprayed over the bituminous material in step 110. The separated bitumen can then be transported to further processing apparatus, such as apparatus used to upgrade the bitumen into commercially useful lighter hydrocarbons. Any manner of separating the disbit into solvent and bitumen can be used, including the use of a froth tank or distillation units.

As noted above, the bitumen-depleted tailings resulting from the mixing and separating steps can include a solvent. Therefore, in some embodiments, the bitumen-depleted tailings are treated for solvent removal and recovery. Any methods suitable for removing solvent from tailings can be used. In some embodiments, treatment for solvent removal includes washing the tailings with the same solvent as used in the mixing step or, alternatively, a secondary solvent that is lighter than the solvent sprayed over the bituminous material. The secondary washing can take place in a secondary mixing drum similar or identical to the one or more primary mixing drums described above and used to mix bituminous material and solvent. In some embodiments the second wash stage is carried out using second solvent in the vapor phase or supercritical second solvent to minimize the second solvent remaining in the bitumen depleted tailings after washing. The washing with second solvent can also include one or more washing stages. In addition to removing first disbit remaining after the first contact stage, washing the tailings with secondary solvent can result in the tailings becoming further bitumen depleted and wet with secondary solvent. Accordingly, the secondary solvent wet tailings can be further processed for secondary solvent recovery, such as via a column, filtration device, or by drying or flashing to remove the light secondary solvent prior to discharge of the tailings as a final waste.

In some embodiments, the washing of the bitumen-depleted tailings with secondary solvent can be carried out in the same mixing drum used for spraying the initial bituminous material with the first solvent. In such embodiments, the mixing drum will typically include a screen liner so that separation of the disbit and the bitumen-depleted tailings can be carried out within the mixing drum. In practice, washing with a second solvent can begin by terminating the spraying of first solvent into the mixing drum and removing the disbit separated from the bitumen-depleted tailings via the screen liner from the mixing drum. The bitumen-depleted tailings can remain in the mixing drum. Second solvent is then sprayed over the bitumen-depleted tailings inside the mixing drum. In some embodiments, this can be accomplished by using the same solvent inlet previously used to spray first solvent over the bituminous material, including the same spray bar used for the first solvent. Rotation of the drum to promote mixing between the tailings and the secondary solvent can be carried out in a similar or identical fashion as described above. The secondary solvent washes the first solvent from the tailings and creates a mixture of first solvent and secondary solvent that can pass through the screen liner located inside the mixing drum. The washed tailings, which now include some entrained secondary solvent, remain within the screen liner and can be processed to remove secondary solvent from the tailings, including by removing the tailings from the mixing drum and heating the tailings to the point of evaporating the secondary solvent.

In embodiments where the mixing drum does not include a screen liner or other internal separation device, the slurry can be removed from the mixing drum and then be subjected to separation of the disbit from the bitumen-depleted tailings. The bitumen-depleted tailings can then be transported back into the same mixing drum used for the first solvent spraying step and be subjected to second solvent washing as described above. Any suitable apparatus can be used to separate the slurry, including but not limited to, a thickener. When a thickener is used, the slurry is received by the thickener, and the thickener separates the slurry such that it produces a stream of disbit and a stream of bitumen-depleted tailings.

The second solvent can be any solvent capable of washing the first solvent from the bitumen-depleted tailings. In some embodiments, the second solvent is a solvent having a lower boiling point temperature than the first solvent. In some embodiments, the second solvent is a paraffinic solvent, such as pentane or butane. In some embodiments, the second solvent is a polar solvent.

The solvent contained in the bitumen-depleted tailings can also be removed and recovered from the tailings through conventional heating methods, wherein the tailings are heated to evaporate the solvent. The evaporated solvent can then be condensed and reused. In embodiments where the solvent is a blend of paraffinic and aromatic solvent, the tailings can include predominantly paraffinic solvent and very little aromatic solvent. In such embodiments, the dryer duty will be lower, the dryer cycle will be faster, and a higher throughput will be achieved. In an industrial application, the drying can be heat integrated with other process steps (e.g., distillation), resulting in minimal to no additional heat requirements for evaporation of solvent from the bitumen depleted tailings.

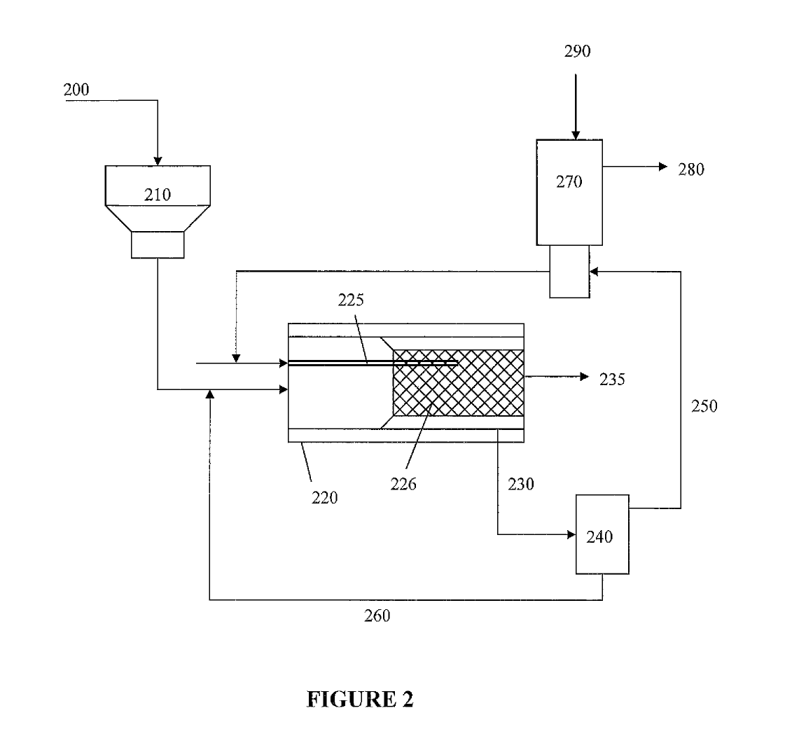

FIG. 2 illustrates a process diagram of embodiments described above. Bituminous material 200 is run through a crusher 210 to reduce the size of larger pieces of the bituminous material 200. Once crushed, the bituminous material 200 is transported to a mixing drum 220 that includes a spray bar 225. As the bituminous material 200 enters the mixing drum 220, solvent is sprayed over the bituminous material 200 via the spray bar 225. The mixing drum 220 rotates during the spraying and a slurry is formed. The slurry generally contains a bitumen-enriched solvent phase and a bitumen-depleted tailings phase. A screen liner 226 inside of the mixing drum 220 works to separate the bitumen-enriched solvent phase from the bitumen-depleted tailings phase 235. The bitumen enriched solvent phase 230 leaves the mixing drum and is sent to a separation unit 240, such as a hydrocyclone. The separation unit 240 works to separate any solid material from the bitumen-enriched solvent phase 230. Accordingly, the separation unit 240 creates a purified disbit stream 250 and a solid materials stream 260. The solid materials stream 260 is routed back to the mixing drum 226 to undergo further mixing with solvent inside the mixing drum 220 or can be subjected to a smaller dedicated washing process to remove any remaining disbit. Alternatively, if sufficiently clean, the solid materials stream 260 can be added back with the bitumen-depleted tailings phase 235. The purified disbit stream 250 is sent to a storage tank 270 where several different processing steps can occur. In some instances, the disbit stream 250 will be suitable for use as solvent that is sprayed over bituminous material inside of the mixing drum 220. In some instances, the amount of solvent and bitumen in the disbit stream 250 will need to be adjusted, at which point bitumen 280 can be removed from the disbit 250 in the storage tank 270 or solvent 290 can be added to the storage tank 270. In still other instances, the disbit 250 will be separated into solvent and bitumen 280, with the solvent being sprayed over further bituminous material inside of the mixing drum 250 and the bitumen 280 being sent to an upgrader.

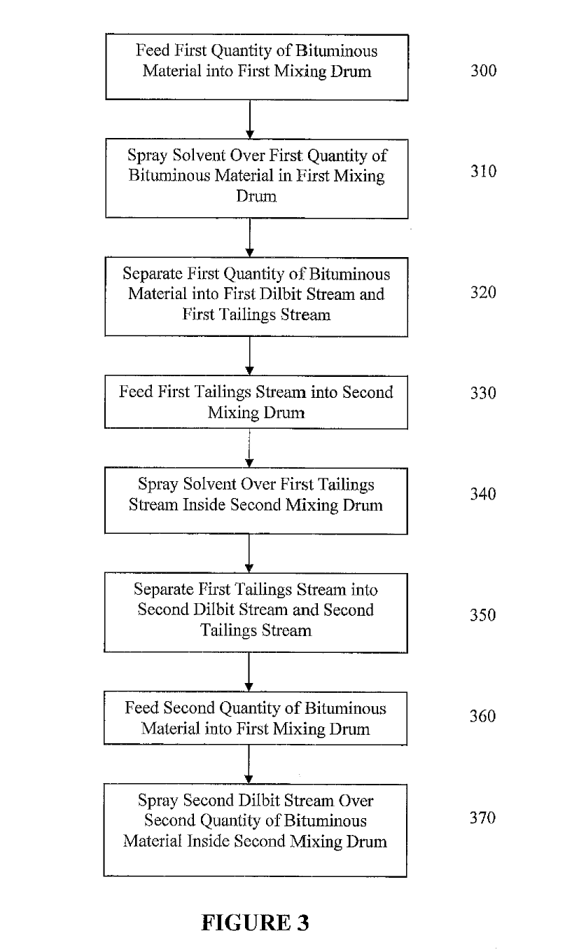

In some embodiments, a method of extracting bitumen from bituminous material utilizes two or more mixing drums aligned in series. With reference to FIG. 3, the method can include a step 300 of feeding a first quantity of bituminous material into a first mixing drum, a step 310 of spraying solvent over the first quantity of bituminous material inside the first mixing drum, a step 320 of separating the first quantity of bituminous material into a first disbit stream and a first tailings stream, a step 330 of feeding the first tailings stream into a second mixing drum, a step 340 of spraying solvent over the first tailings stream inside the second mixing drum, a step 350 of separating the first tailings stream into a second disbit stream and a second tailings stream, a step 360 of feeding a second quantity of bituminous material into the first mixing drum, and a step 370 of spraying the second disbit stream over the second quantity of bituminous material inside the first mixing drum.

In step 300, a first quantity of bituminous material is fed into a first mixing drum. The bituminous material and the mixing drum used in step 300 may be similar or identical to the bituminous material and mixing drum described in greater detail above. Similarly, the manner of feeding the bituminous material into the first mixing drum can be similar or identical to the feeding step 100 described in greater detail above. The first quantity of bituminous material used in step 300 can be any quantity that can be processed in the mixing drum. Accordingly, the size of the mixing drum can impact the size of the first quantity of bituminous material.

In step 310, a solvent is sprayed over the first quantity of bituminous material inside the first mixing drum. Step 310 can be similar or identical to step 110 described in greater detail above, including the type and amount of solvent used, the rotation of the mixing drum during spraying, and the delivery of solvent via a spray bar extending through the mixing drum. Similarly, the result of step 310 is similar or identical to step 110 described in greater detail above. Mixing the solvent and bituminous material results in the formation of a slurry containing bitumen dissolved in solvent and solvent-wet inert material (that may or may not have some bitumen occluded thereon). In some embodiments, the solvent sprayed over the bituminous material in step 310 is an aromatic solvent, such as those aromatic solvents described in greater detail above. In some embodiments, the solvent used in step 310 is a blend of aromatic solvent and paraffinic solvent, such as a blend including from 20 to 25% aromatic solvent and the balance paraffinic solvent.

In step 320, the first quantity of bituminous material, which is now solvent wet and in the form of the previously described slurry, is separated into a first disbit stream and a first tailings stream. The manner of separating the slurry into these two components is similar or identical to the separation methods described above in connection with step 120. Thus, in some embodiments, the mixing drum includes a liner screen that filters the disbit away from the tailings. Alternatively, the slurry is removed from the mixing drum and separated external to the mixing drum, such as in a thickener. The separated first disbit stream and the first tailings stream can be similar or identical to the disbit and tailings described above in step 120. Accordingly, the first disbit stream can include primarily bitumen and solvent and the first tailings stream can include solvent, water, and inert materials, such as sand and clay. As also mentioned above in the discussion of step 120, the first disbit stream can further include a relatively small amount of solid particles and the first tailings stream can include a bitumen content, including bitumen that remains occluded on the inert material and/or bitumen that is dissolved in solvent that remains with the tailings.

In step 330, the first tailings stream produced from the separation step 320 is transported and fed in to a second mixing drum. The first tailings stream can be transported to the second mixing drum in any suitable manner, including through the use of pumps, conveyors, chutes, or screw feeders. The second mixing drum can be similar or identical to the first mixing drum. While the shape and orientation of the second mixing drum is not limited, in some embodiments the second mixing drum is a horizontally positioned cylindrical drum. As with the previously described mixing drum, the second mixing drum can be capable of rotating about its axis to promote mixing between the first tailings stream and solvent injected therein, and can also include a screen liner for separating materials after mixing. The size of the second mixing drum is also not limited, and will generally be selected based on the amount of tailings to be processed inside of the second mixing drum. In some embodiments, the second mixing drum is a trommel or pulper as described in greater detail above.

Alternatively, step 330 can be omitted. In such embodiments, the first tailings stream can remain in the first mixing drum, and further solvent processing of the tailings can be carried out in the same mixing drum used to spray first solvent over the bituminous material. If the first mixing drum does not include a mechanism for separating the slurry into a disbit stream and a tailings stream, the slurry can be temporarily removed from the mixing drum to separate the slurry into a disbit stream and a tailings stream, after which the tailings stream can be transported back into the first mixing drum. Any suitable method for separating the slurry external to the mixing drum can be used, including using a filter press or screening mechanism.

In step 340, solvent is sprayed over the first tailings stream inside the second mixing drum (or, in embodiments where step 330 is omitted, in the first mixing drum). The manner in which the solvent is sprayed over the first tailings stream can be similar or identical to the spraying step 110 described in greater detail above. Thus, in some embodiments, the solvent is sprayed over the first tailings stream using a spray bar that extends into the second mixing drum.

Any solvent described herein can be used in step 340. In some embodiments, the solvent is disbit. When disbit is used as the solvent, the amount of disbit used in step 340 can be based on the same ratios discussed above in step 110. More specifically, the amount of disbit used in step 340 can be based on the bitumen content of the tailings, and range from a solvent (i.e., disbit) to bitumen ratio of from 0.5:1 to 9:1 on a volume basis. In other embodiments, including embodiments where step 310 is carried out using a blend of aromatic solvent and paraffinic solvent, the solvent used in step 340 is a similar blend or a paraffinic solvent.

When disbit is used as the solvent in step 340, the source of the disbit is not limited, although in some preferred embodiments, the source of the disbit is downstream processing steps. More specifically, and as described in greater detail below, the disbit may be originated from an additional mixing drum located downstream from and connected in series with the first and second mixing drums. For example, where a third mixing drum is connected in series with the first and second mixing drum, the third mixing drum can receive tailings produced from the second mixing drum. Treatment of these tailings in the third mixing drum with solvent will produce disbit, which once separated and removed from the third mixing drum, can be recycled back and used as the disbit sprayed over the tailings in the second mixing drum. Generally speaking, disbit produced from a mixing drum can be used as the solvent in the mixing drum immediately prior in a series of mixing drums.

In some embodiments, the solvent sprayed over the bitumen-depleted tailings in the second mixing drum is a second solvent that is lighter than the first solvent. In this manner, the second mixing drum is used to displace first solvent from the bitumen-depleted tailings. The slurry produced in the second mixing drum can be separated into a bitumen-depleted tailings phase and a solvent mixture phase. The solvent mixture phase can include a mixture of first solvent and second solvent (and potentially a bitumen content), while the bitumen-depleted tailings phase can include residual amounts of second solvent, but little to no first solvent.

In step 350, the slurry produced inside of the second mixing drum by virtue of spraying solvent over the first stream of tailings is separated into a second disbit stream and a second tailings stream. This separation step can be similar or identical to the separation steps 330 and 120 discussed in greater detail above. Accordingly, in some embodiments, the separation is carried out by virtue of a liner screen inside of the second mixing drum that filters the second disbit stream from the second tailings stream, while in other embodiments, the separation is carried out in a separation vessel (such as a thickener) located external to the second mixing drum. The second disbit stream and second tailings stream produced by the separation step can be similar or identical in composition to the disbit and tailings streams described in greater detail above. In some embodiments, the disbit and tailings streams are lower in bitumen content then the disbit and tailings stream produced in the first mixing drum.

Once the second mixing drum has produced a second disbit stream, a step 360 of feeding a second quantity of bituminous material into the first mixing drum and a step 370 of spraying the second stream of disbit over the second quantity of bituminous material inside of the first mixing drum can take place. In this manner, the overall bitumen extraction method generates its own solvent and becomes at least partially self-sufficient. The disbit moves in a counter-flow direction to the solids and becomes more loaded with bitumen after each stage (i.e., mixing drum). Thus, the disbit leaving the first mixing drum and which has passed through one or more downstream mixing drums reaches optimal bitumen content for further processing or separation.

Step 360 of feeding a second quantity of bituminous material into the first mixing drum can be similar or identical to step 300 and 100 described in greater detail above. Accordingly, in some embodiments, the bituminous material is oil sands and is fed into the first mixing drum using conveyor belts or the like.

Step 370 of spraying the second disbit stream over the second quantity of bituminous material can be similar or identical to step 310 and 110 described in greater detail above. The disbit can be sprayed over the second quantity of bituminous material using a spray bar extending into the first mixing drum, and the first mixing drum may be rotating about its axis as disbit is sprayed over the bituminous material. Additionally, the result of this step is similar to the spraying steps described above. A slurry is formed that include bitumen dissolved in solvent and solvent-wet tailings. The slurry can be separated as described above, and a continuous process of bitumen extraction is thus established.

In some embodiments, the second stream of disbit is subjected to a further separation step prior to being sprayed over the second quantity of bituminous material inside of the first mixing drum. The separation step generally aims to remove any solid material from the disbit, such as sand that may have filtered through the screen liner inside of the second mixing drum. Any suitable separation method can be used to separate solid material from the second stream of disbit. In some embodiments, the separation is carried out by processing the disbit in a hydrocyclone, a centrifuge, filter, or through a screen.

In some embodiments, the second stream of disbit is heated prior to being injected into the first mixing drum. For example, the second disbit stream can be heated to a temperature in the range of from 20° C. to 60° C. prior to being sprayed over bituminous material inside of the first mixing drum. Any suitable type of heating mechanism can be used to heat the second disbit stream, including the use of a heat exchanger.

The composition of the second stream of disbit may also be adjusted prior to being sprayed over the second quantity of bituminous material. Thus, in scenarios where the disbit sprayed over the bituminous material has a preferred bitumen content and solvent content, additional solvent can be added to the disbit prior to spraying. Other processing steps to adjust the composition of the disbit can also be used, such as removing solvent or bitumen from the disbit.

The first disbit stream and any other disbit produced by the first mixing drum (such as disbit produced after spraying the second stream of disbit over the second quantity of bituminous material and separating the resulting slurry) can be transported to a disbit storage unit. The disbit obtained from the process described above can be market quality bitumen product. Disbit in the disbit storage unit can transported through pipelines and/or be processed to separate the bitumen from the solvent. Any suitable manner of carrying out such a separation can be used, such as by evaporating off the solvent. Solvent separated from the bitumen can be collected and reused in the process, while bitumen can be upgraded into lighter hydrocarbon products. In some embodiments, the disbit leaving the first mixing drum can be subjected to solids separation such as the solids separation discussed in greater detail above prior to being stored in the disbit storage tank. In some embodiments, the separation process uses a hydrocyclone, centrifuge, or screen and removes solid material such as sand that may be contained in the disbit upon removal from the first mixing drum.

The first disbit stream produced from step 320 can typically include from about 30 to about 60 wt % bitumen and from about 40 to about 70 wt % solvent. Relatively small amounts of fine solid material, such as sediment, may also be included in the first disbit stream. In some embodiments, the first disbit stream may include from about 0 to about 15 wt % solid material. The first tailings stream produced from step 320 can generally include from about 70 to about 95 wt % inert materials (such as clay and sand), from about 0 to about 5 wt % water, from about 5 to about 15 wt % solvent, and from about 3 to about 10 wt % bitumen. The second disbit stream produced from step 350 can typically include less bitumen content than the first disbit stream, such as from about 20 to about 50 wt %, and the second tailings stream can typically include less bitumen content then the first tailings stream, such as from about 1% to about 8% wt %. When the slurry produced from step 370 is separated into a disbit stream and a tailings stream, the disbit stream can typically have a bitumen content in the range of from 5 to 30 wt % and the tailings can have a bitumen content in the range of from 0 to 5 wt %.

While FIG. 3 includes two mixing steps carried out in two mixing drums, the method can include further mixing steps that utilize still additional mixing drums. For example, the bitumen-depleted tailings produced in the second mixing drum can be transported to a third mixing drum, where solvent is sprayed over the tailings, the resulting slurry is separated, and the separated disbit is used in the first and/or second mixing drum. Ultimately, any suitable number of mixing steps and mixing drums can be used, with the mixing drums be generally aligned in the order described above (i.e., mixing drum X+1 receives tailings from mixing drum X, and mixing drum X+1 provides a disbit that can be used in any of the preceding mixing drums).

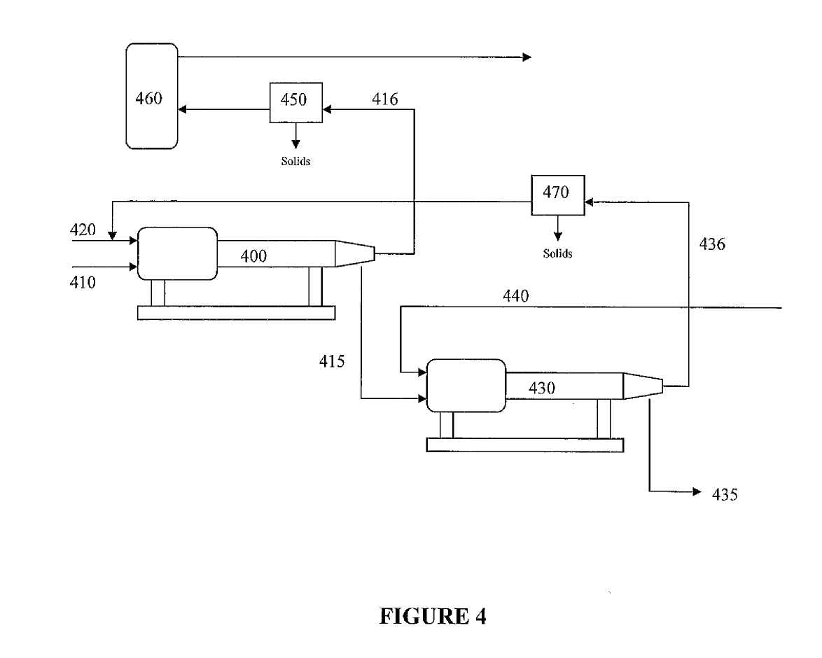

With reference to FIG. 4, a process diagram of embodiments of the above described method is illustrated. A first mixing drum 400 is provided, which receives bituminous material 410 such as oil sand. Solvent 420 (for example, disbit) is sprayed over the bituminous material 410 inside of the first mixing drum 400 to create a slurry that can subsequently be separated inside of the first mixing drum 400. The slurry is separated into a first tailings stream 415 and a first disbit stream 416. The first tailings stream 415 is transported to a second mixing drum 430. Disbit 440 originating from downstream processes is sprayed over the first tailings stream 415 inside of the second mixing drum 430 to create a slurry, although in some embodiments, fresh solvent can be used in place of disbit 440. The slurry is then separated into the a second tailings stream 435 and a second disbit stream 436. The second tailings stream 435 can either be subjected to further bitumen extraction processing, such as in a third mixing drum, or treated for solvent removal and deposited as waste material. The second disbit stream 436 is transported first to a separation unit 470. The separation unit 470 removes solid material that may be present in the disbit stream 436. The disbit stream 436 (or a portion thereof) is then transported back to the first mixing drum 400, where it can be sprayed over additional bituminous material 410 being fed into the first mixing drum 400.

The first disbit stream 416 leaving the first mixing drum 400 can be transported to a separation unit 450 that is similar to the separation unit 470. The separation unit 450 acts to remove solid material from the first disbit stream 416 prior to sending the first disbit stream 416 to a disbit storage unit 460. From the disbit storage unit 460, the first disbit stream 416 can be sent to further processing units, such as unit for separating the bitumen from the solvent.

In some embodiments, systems that can be used to carry out the bitumen extraction methods described above include a first mixing drum, a first separation unit, a second mixing drum, and (optionally) a disbit storage unit. The first mixing drum is generally similar or identical to the mixing drums described in greater detail above, and includes a first disbit inlet, a first disbit outlet, and a first tailings outlet. The first separation unit is also similar or identical to the separation units discussed above, and is generally used to separate solid material from disbit that leaves the first mixing drum. The first separation unit therefore includes a second disbit inlet that is in fluid communication with the first disbit outlet of first mixing drum. In this manner, disbit leaving the first mixing drum can be transported into the first separation unit. The first separation unit also includes a cleaned disbit outlet for transporting cleaned disbit (i.e., disbit with less solid material than when the disbit entered the first separation unit) out of the first separation unit, and a solid materials outlet for transporting separated solid material out of the first separation unit.

The second mixing drum is generally similar or identical to the mixing drums described in greater detail above, and includes a first tailings inlet. The first tailings inlet is in fluid communication with the first tailings outlet of the first mixing drum, and allows for the first tailings stream leaving the first mixing drum to be fed into the second mixing drum. Inside the second mixing drum the first tailings unit will be subjected to bitumen extraction by being sprayed with solvent that dissolves bitumen that remains with the first tailings and subsequently separating the dissolved bitumen from the tailings. Accordingly, the second mixing drum also includes a second disbit outlet and a second tailings outlet for removing each component from the second mixing drum.

The second disbit outlet of the second mixing drum is in fluid communication with the first disbit inlet of the first mixing drum so that disbit leaving the second mixing drum can be sprayed over bituminous material being fed into the first mixing drum. In this manner, the solvent needed for bitumen extraction in the first mixing drum is provided by the disbit produced in the second mixing drum, and the bitumen content of the disbit moving in a countercurrent direction through one or more mixing drums can be increased to an optimal concentration for downstream processing or separation.

The disbit storage unit of the system includes a cleaned disbit inlet that is in fluid communication with the cleaned disbit outlet of the first separation unit. In this manner, the cleaned disbit exiting the first separation unit can be transported to and stored in the disbit storage unit. Disbit in the disbit storage unit can subsequently be transported to downstream processing units, such as a distillation unit for separating the solvent from the bitumen.

The system described above can also include more than two mixing drums. Any additional mixing drums are used in the same manner as the first two mixing drums. For example, a third mixing drum would receive the tailings from the second mixing drum and can be used to provide a disbit stream that is used in the first and/or second mixing drum.

In some embodiments, the bitumen extraction method and the mixing drum configurations described above are used in conjunction with additional downstream processing. Typically, the downstream processing includes conducting further bitumen extraction processing on the bituminous material or the tailings exiting the mixing drum. By conducting further processing on the bituminous material or tailings, the overall extraction rate of bitumen from the initial bituminous material can be improved.

In some embodiments, one or more hydrocyclones are used to carry out further bitumen extraction on material exiting the mixing drum. More specifically, the one or more hydrocyclones can be used when separation of disbit and tailings is not carried out inside of the mixing drums and instead the mixing drum outputs a slurry of solvent and bituminous material. Such a slurry is injected into a hydrocyclone, which acts to separate the disbit from the tailings. The disbit reports to the overflow stream of the hydrocyclone while the tailings report to the underflow of the hydrocyclone. In this manner, the mixing drum need not include separation apparatus (such as an internal screen). The disbit leaving the hydrocyclone can be sent to a separation unit to separate the solvent from the bitumen, or can be recycled for use as a solvent in bitumen extraction. The tailings can be deposited back into the area from which the bituminous material was mined.

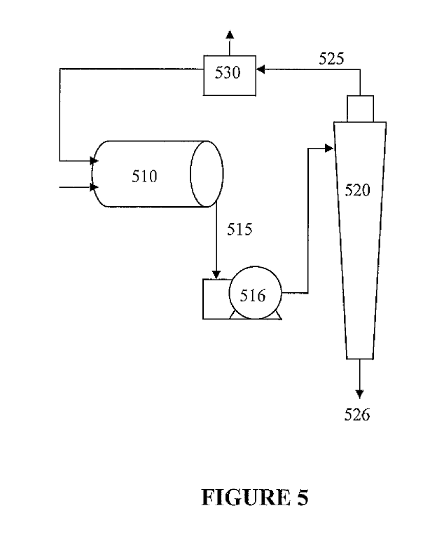

FIG. 5 illustrates a general schematic of a mixing drum 510 having a single hydrocyclone 520 located downstream of the mixing drum 510. In such a set up, the hydrocyclone 520 is used to separate the slurry 515 that exits the mixing drum 510 into a disbit stream 525 and a tailings stream 526. As shown in FIG. 5, the disbit stream 525 leaving the hydrocylcone can be sent to a separator 530 for separating the disbit stream 525 into solvent and bitumen. The separator 530 can either perform a total separation, or as shown in FIG. 5, can remove a portion of bitumen while recycling the disbit back to the mixing drum 510. Once the disbit is recycled back to the mixing drum 510, it can be used in subsequent mixing steps with bituminous material inside of the mixing drum 510. The tailings stream 526 exits the bottom of the hydrocyclone 520 and can be deposited as mine backfill.

Typical hydrocyclones suitable for use in the above described method and system include hydrocyclone separators that utilize centrifugal forces to separate materials of different density, size, and/or shape. The hydrocyclone will typically include a stationary vessel having an upper cylindrical section narrowing to form a conical base. The slurry is introduced into the hydrocyclone at a direction generally perpendicular to the axis of the hydrocyclone. This induces a spiral rotation on the slurry inside the hydrocyclone and enhances the radial acceleration on the tailings within the slurry. The hydrocyclone also typically includes two outlets. The underflow outlet is situated at the apex of the cone, and the overflow outlet is an axial tube rising to the vessel top (sometimes also called the vortex finder).

When the density of the solid tailings phase is greater than that of the fluid disbit phase, the heavier solid particles migrate quickly towards the cone wall where the flow is directed downwards. Lower density solid particles migrate more slowly and therefore may be captured in the upward spiral flow and exit from vortex finder via the low pressure center. Factors affecting the separation efficiency include fluid velocity, density, and viscosity, as well as the mass, size, and density of the tailings particles. The geometric configuration of the hydrocyclone can also play a role in separation efficiency. Parameters that can be varied to adjust separation efficiency include cyclone diameter, inlet width and height, overflow diameter, position of the vortex finder, height of the cylindrical chamber, total height of the hydrocyclone, and underflow diameter.

The manner of transporting the slurry from the mixing drum 516 to the hydrocyclone 520 can include any suitable mechanism for moving slurry away from the outlet of the mixing drum 510 and into the hydrocyclone 520. In some embodiments, piping is used to connect the outlet of the mixing drum 510 to the inlet of the hydrocyclone 520. A pump 530 can also be used to ensure the movement of the slurry from the mixing drum 510 to the hydrocyclone 520.

In some embodiments, including embodiments where separation of the slurry does not occur inside of the mixing drum, the slurry leaving the mixing drum is sent to a separation unit prior to being sent to the hydrocyclone. Exemplary separation units suitable for use in the method include, but are not limited to, thickeners, clarifiers, or filters. Such separation units can be desirable when clays are present in the slurry leaving the mixing drum. Separation units such as thickeners can remove these clays and produce an overflow of disbit having reduced or eliminated clay content. The underflow of the separation unit generally includes the bitumen-depleted tailings having a solvent content, and this stream can be sent to the hydrocyclone. In some embodiments, the bitumen-depleted tails leaving a separation unit can be in the form a filter cake, in which ease additional solvent can be added to the filter cake to re-slurry the material prior to sending the tailings to the hydrocyclone.

In some embodiments, two or more hydrocyclones aligned in series and located downstream of the mixing drum can be used to improve the overall amount of bitumen recovered from the slurry. The two or more hydrocyclones can use a counter current flow wherein disbit recovered from one hydrocyclone is recycled back and added to the slurry being introduced to the previous hydrocyclone. By so doing, the overall bitumen extraction efficiency can be improved. Any number of hydrocyclones can be used in such a system, and calculations or experimentation can be carried out to determine the number of hydrocyclones necessary to maximize bitumen extraction. In some embodiments, the number of hydrocyclones used depends on how efficiently the hydrocyclones are at “washing” the disbit from the tailings, with additional hydrocyclones necessary when the “washing” is less efficient.

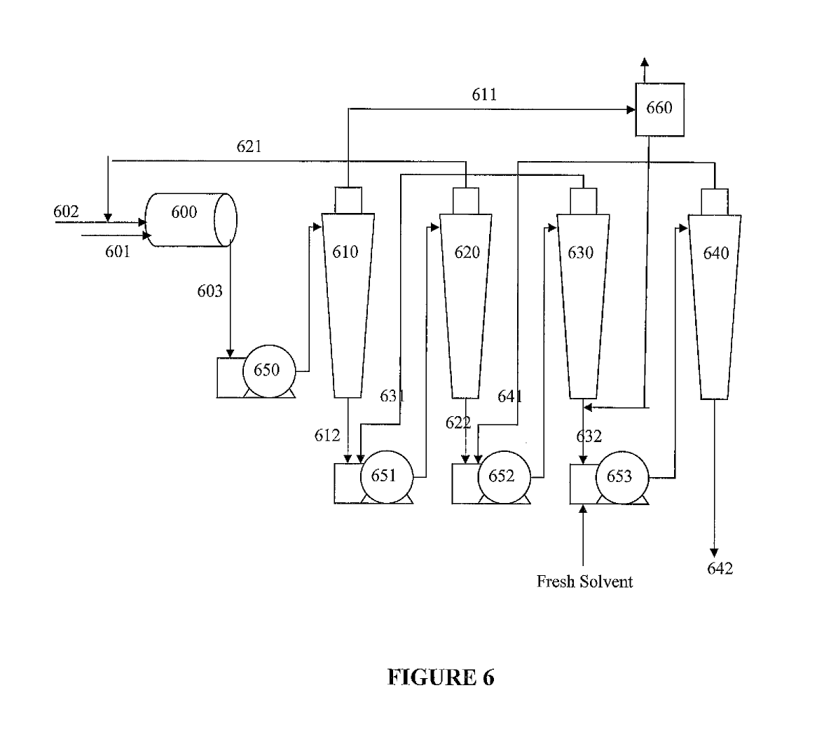

FIG. 6 illustrates a system where four hydrocyclones 610, 620, 630, 640 are aligned in series downstream of the mixing drum 600. A pump 650, 651, 652, 653 is placed between the mixing drum 600 and the first hydrocyclone 610, between the first hydrocyclone 610 and the second hydrocyclone 620, between the second hydrocyclone 620 and the third hydrocyclone 630, and between the third hydrocyclone 630 and the fourth hydrocyclone 640 in order to assist in the movement of material between each of the units. The mixing drum 600 is provided for producing a slurry of bituminous material and solvent, although in some embodiments the pump box of pump 650 can serve as both the mixing drum 600 and the pump 650 when solvent and bituminous material are fed directly into the pump 650. The hydrocyclones 610, 620, 630, 640 are provided for separating the slurry into disbit and tailings. In the series of hydrocyclones, the tailings leaving each hydrocyclone are mixed with additional solvent (e.g., disbit) and sent into the next hydrocyclone in the series until a tailings stream substantially free of bitumen is produced. Simultaneously, the disbit stream leaving each hydrocyclone is sent to be mixed with the tailings entering the previous hydrocyclone in the series until a disbit sufficiently loaded with bitumen is produced in the first hydrocyclone in the series.

Referring still to FIG. 6, in operation the method begins with introducing bituminous material 601 into the mixing drum 600 and spraying solvent 602 over the bituminous material 601 inside the mixing drum 600 as described in greater detail above. The mixing drum 600 does not include internal separation apparatus, and therefore outputs a slurry 603 including bituminous material and solvent. Enough solvent 602 is sprayed over the bituminous material 601 to ensure the slurry 603 is pumpable. While not shown in FIG. 6, the slurry can be pumped to a separation unit, such as the thickener described previously, to remove, for example, clays from the slurry and produce a tailings stream that is sent to the hydrocyclones. Pump 650 pumps the slurry 603 to the first hydrocyclone 610, where the slurry 603 is injected into the hydrocyclone 610 at a direction generally perpendicular to the axis of the hydrocyclone 610. Centrifugal forces act on the slurry 603 and separate the slurry into a first disbit stream 611 and a first tailings stream 612. The first disbit stream 611 can include some of the less dense solid particles of the slurry 603, and therefore can be sent to a separation unit 660 that removes fine solids from the first disbit stream 611. In some embodiments, an objective of the hydrocyclone system is to have the first hydrocyclone 610 produce a first disbit stream 611 that includes a solids level of less than 1000 wppm.

The first tailings stream 612 leaving the first hydrocyclone 610 is transported to the second hydrocyclone 620. Pump 651 helps to move first tailings stream 612 towards the second hydrocyclone 620 and can also serve as a mechanism for adding further disbit to the first tailings stream 612 to ensure the first tailings stream 612 is pumpable. As discussed in greater detail below, the disbit added to the first tailings stream 612 can come from the third hydrocyclone 630. The mixture of the first tailings stream 612 and the disbit is transported to and injected into the second hydrocyclone 620 at a direction generally perpendicular to the axis of the second hydrocyclone 620. As with the first hydrocyclone 610, centrifugal forces act on the first tailings stream 612 to separate the first tailings stream into a second disbit stream 621 and a second tailings stream 622. Because the slurry 603 leaving the mixing drum 600 is in a pumpable condition by virtue of the amount of solvent 602 added to the bituminous material 601 inside the mixing drum 600, the second disbit stream 621 need not be added with the slurry 603. Instead, the second disbit stream 621 can be used as make-up solvent to be used inside the mixing drum 600 and further load the second disbit stream 621 with additional bitumen content. Accordingly, the second disbit stream 621 can be transported to the mixing drum 600 and combined with solvent 602 entering the mixing drum 600. Alternatively, the second disbit stream 621 can replace the solvent 602, thereby making the overall system generally self-sufficient (i.e., no fresh solvent is needed for the mixing drum 603 stage after start up).

The second tailings stream 622 is transported to the third hydrocyclone 630 in much the same manner as the first tailings stream 612 is transported to the second hydrocyclone 620, including the use of a pump 652 to move the second tailings stream 622 towards the third hydrocyclone 630. The second tailings stream 622 can be mixed with disbit obtained from the fourth hydrocyclone 640 in order to ensure that the second tailings stream 622 is pumpable. Once transported into the third hydrocyclone 630, the second tailings stream 622 is separated into a third disbit stream 631 and a third tailings stream 632. As mentioned above, the third disbit stream 631 is recycled back in the system to be added with the first tailings stream 612 being sent into the second hydrocyclone 620.

The third tailings stream 632 leaving the third hydrocyclone 630 is transported towards the fourth hydrocyclone 640. During the transport, the third tailings stream 632 can be mixed with additional tailings solids that are obtained when the first disbit stream 611 is sent to the separation unit 660 to remove less dense solid particles that report to the overflow in the first hydrocyclone 610 rather than the underflow. The third tailings stream 632 can also be mixed with solvent to ensure the third tailings stream 632 is pumpable. The solvent will typically be a fresh solvent rather than a disbit stream obtained from another hydrocyclone in the system. Once solvent and/or additional tailings solids are added to the third tailings stream 632, the third tailings stream 632 is injected into the fourth hydrocyclone 640 for separation into a fourth disbit stream 641 and a fourth tailings stream 642. The fourth disbit stream 641 can be recycled back to be mixed with the second tailings stream 622 being transported to the third hydrocyclone 630.

After the fourth hydrocyclone 640, the fourth tailings stream 642 can be in a condition where it is sufficiently stripped of bitumen material and is therefore a final waste product of the system and method. The fourth tailings stream 642 can include a solvent content, and in some embodiments, the fourth tailings stream 642 can be sent to a solvent recovery unit where the solvent is removed from the tailings. Any solvent recovery unit or system can be used to remove the solvent from the tailings, including a belt dryer to flash recover the solvent. Solvent can also be recovered using wash columns, wherein the tailings are packed in a column and solvent is displaced out of the tailings by the introduction into the column of various wash fluids.

As noted above, any number of hydrocyclones can be used to carry out the bitumen extraction. Regardless of the number of hydrocyclones used, general operating procedures can be followed. For example, the last hydrocyclone in the series will produce a tailings stream that has the lowest bitumen content of any of the tailings streams produced by the various hydrocyclones in the series and will not be sent to another hydrocyclone for the purpose of separating disbit from the tailings. However, the tailings leaving the last hydrocyclone in the series may include a solvent content that can be recovered using various solvent recovery processes. Additionally, the first hydrocyclone in the series will produce a disbit stream that has the highest bitumen content of the any of the disbit streams produced by the various hydrocyclones in the series, and will therefore be the disbit stream that is treated as a product of the system rather than being recycled back into the system. In some embodiments, the disbit from the first hydrocyclone in a series of hydrocyclones will be sent to a separation unit to separate solvent from the bitumen, and the separated bitumen will then be sent to further processing units where bitumen upgrading takes place. The solvent removed from the bitumen can be recycled back in the process. Furthermore, with the exception of the disbit stream produced by the first hydrocyclone, the disbit leaving each hydrocyclone in the series will be mixed with the tailings entering the preceding hydrocyclone in the series. As described above, in the case of the second hydrocyclone in the series, the disbit can be used as the solvent for the mixing drum step rather than being added to the slurry produced by the mixing drum in order to make the overall method more self sufficient.

As noted above, disbit from each hydrocyclone is mixed with tailings entering the previous hydrocyclone in order to ensure that the tailings are pumpable. In some embodiments, the S:B ratio used in the initial mixing drum is increased so that the disbit obtained from each hydrocyclone has a suitably high amount of solvent to make the tailings pumpable when mixed with the disbit. In embodiments described above where one or more mixing drums are used to extract bitumen, the S:B ratio can be within the range of 0.5:1 to 9:1. Correspondingly, a mixed solvent might contain higher aromatic content when using the higher S:B ratios to maintain the asphaltenes in solution. When one or more hydrocyclones are used downstream of the mixing drum, the S:B ratio used in the mixing drum can range from 1.5:1 to 10:1, although any S:B ratio that produces a pumpable slurry can be used. In addition to helping to ensure that addition of the disbit to the tailings makes the tailings pumpable, the increased S:B ratio can also improve “wash” efficiency inside of the hydrocyclones (i.e., result in improved separation of disbit and tailings). In some embodiments, the cyclone feed is maintained at the correct solids content for pumping by recycling a portion of the cyclone overflow. Each hydrocyclone in the circuit can be operated at a different S:B ratio to help accomplish the above goals.

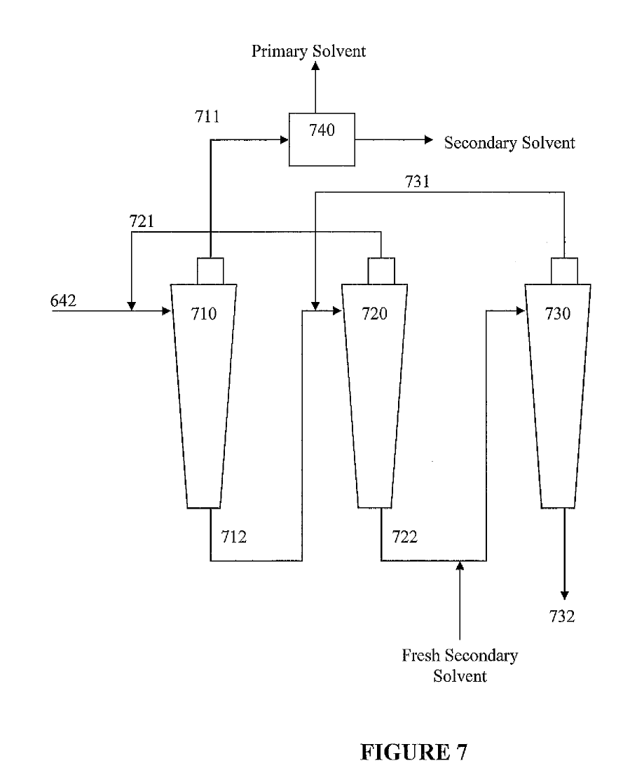

In some embodiments, a second series of hydrocyclones can be used to remove the solvent from the final tailings produced by the first series of hydrocyclones. The second series of hydrocyclones are arranged and operated in a similar or identical manner to the first series of hydrocyclones. As shown in FIG. 7, the final tailings 642 produced by the first series of hydrocyclones are mixed with a second solvent mixture 721 that includes primary solvent (i.e., the solvent used in the first series of hydrocyclones to dissolve and extract bitumen) and secondary solvent (i.e., wash solvent selected for displacing first solvent out of the tailings) to form a slurry. The mixture of primary solvent and secondary solvent can be obtained from the overflow of the second hydrocyclone 720 in the second series of hydrocyclones. The slurry is then injected into a first hydrocyclone 710, which uses centrifugal force to separate a first solvent mixture 711 from a first tailings 712. The first solvent mixture 711 of the first hydrocyclone 710 can be sent to a separation unit 740 where primary solvent is separated from secondary solvent, while the first tailings 712 are sent to the second hydrocyclone 720. Prior to being injected into the second hydrocyclone 720, the first tailings 712 are mixed with a third solvent mixture 731 obtained from the overflow of the third (and in this case, final) hydrocyclone 730. The second hydrocyclone 720 produces a second solvent mixture 721 which, as noted previously, is mixed with the final tailings 642 from the first series of hydrocyclones, and a second tailings stream 722, which is mixed with fresh secondary solvent and injected into the third (and in this case, final) hydrocyclone 730. The third tailings 732 produced by the third hydrocyclone 730 have the smallest amount of primary solvent of any of the tailings produced in the second series of hydrocyclones, and the third solvent mixture 731 is mixed with the second tailings 722.

In some embodiments, the downstream processing utilizes one or more packed columns for conducting further bitumen extraction on the bitumen-depleted tailings produced by the upstream mixing drum (or mixing drums). The processing that takes place in the packed column includes passing a first type of solvent through the tailings packed in the column(s) one or more times, followed by passing a second type of solvent through the tailings packed in the column(s). In some embodiments, the first solvent is the same solvent used in the mixing drums to extract bitumen from the bituminous material (such as, e.g., aromatic solvent), while the second solvent is a solvent capable of displacing first solvent out of the tailings (such as a paraffinic solvent or a polar solvent). When the first solvent passes through the packed column(s), the first solvent dissolves bitumen remaining in the tailings and carries it through and out of the column as a bitumen laden solvent. When the second solvent passes through the packed columns, the second solvent displaces the first solvent (that may include further bitumen) from the tailings.

In embodiments where the first solvent used in the packed column is a blend of aromatic solvent and paraffinic solvent as described in greater detail above, the throughput of the overall process may be faster than when aromatic solvent alone is used due to the lower viscosity of the solvent mixture. Similarly, the use of a blended solvent can have higher throughput than a single paraffinic solvent due to no precipitating asphaltenes in the filter bed, which can block pore volume. In each case, the liquid plug of solvent travels through the material more quickly and thus can save on capex and apex costs.

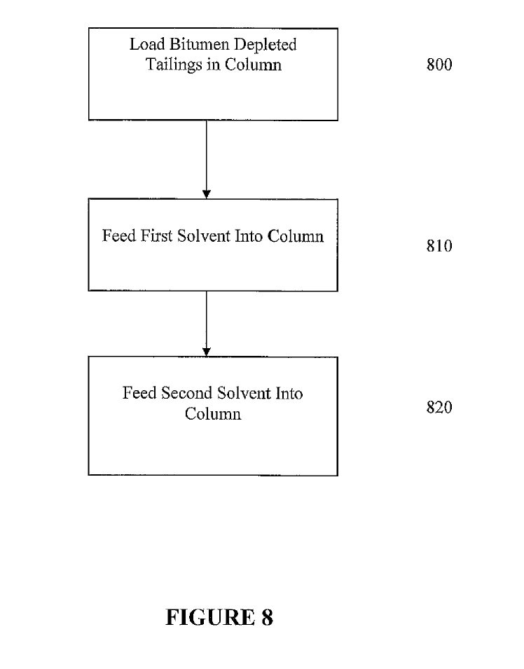

With reference to FIG. 8, the downstream processing method can include a step 800 of loading bitumen-depleted tailings in a column, a step 810 of feeding a first quantity of first solvent into the column, and a step 820 of feeding a first quantity of second solvent into the column.

With reference to the step 800 of loading bitumen-depleted tailings in a column, the bitumen-depleted tailings generally include the tailings produced by the upstream mixing drum or drums. In embodiments where multiple mixing drums are used upstream of the column, the tailings can come from the last mixing drum in the series of mixing drums. The bitumen-depleted tailings will include a first solvent content. The first solvent content can include first solvent having bitumen dissolved therein.

The column into which the tailings are loaded can be any type of column suitable for carrying out bitumen extraction. In some embodiments, the column has a generally vertical orientation. The vertical orientation may include aligning the column substantially perpendicular to the ground, but also may include orientations where the column forms angles less than 90° with the ground. In some embodiments, the column can oriented at an angle anywhere within the range of from about 1° to 90° with the ground. In a preferred embodiment, the column is oriented at an angle anywhere within the range of from about 15° to 90° with the ground.

The material of construction for the vertical column is also not limited. Any material that will hold the bitumen material within the column can be used. The material may also preferably be a non-porous material such that various solvents fed into the column may only exit the column from one of the ends of the vertical column. The material can be a corrosive-resistant material so as to withstand the potentially corrosive components fed into the column as well as any potentially corrosive materials.

The shape of the column is not limited to a specific configuration. Generally speaking, the column can have two ends opposite one another, designated a top end and a bottom end. The cross-section of the column can be any shape, such as a circle, oval, square, rectangle, or the like. In some embodiments, the cross-section of the column changes along the height of the column, including both the shape and size of the column cross-section. The column can be a straight line column having no bends or curves along the height of the vertical column. Alternatively, the column can include one or more bends or curves.

A wide variety of dimensions can be used for the column, including the height, inner cross sectional diameter and outer cross sectional diameter of the column. In some embodiments, the ratio of height to inner cross sectional diameter ranges from 0.25:1 to 15:1.

The tailings can be loaded in the column according to any suitable method. For example, in some embodiments, the tailings are generally loaded in the column by introducing the tailings into the column at the top end of the column. The bottom end of the column can be blocked, such as by a removable plug or by virtue of the bottom end of the column resting against the floor. In some embodiments, a metal filter screen at the bottom end of the column can be used to maintain the bitumen material in the vertical column. In such configurations, introducing the tailings at the top end of the column fills the column with tailings.

In some embodiments, the tailings loaded into the column by pouring the bitumen material into the top end of the column. In one example, tailings can be transported to the column via a conveyor having one end positioned over the top end of the column. In such a configuration, the tailings fall into the column after it is transported over the end of the conveyor positioned over the column. Manual methods of loading tailings into the column can also be used such as mechanical or manual shoveling the tailings into column. For larger diameter columns, automatic distribution systems can be used, such as the systems disclosed in U.S. Pat. Nos. 4,555,210 and 6,729,365.

The amount of tailings loaded in the column may be such that the tailings substantially fill the column. In some embodiments, the tailings may be added to the column to occupy 90% or more of the volume of the column. In some embodiments, the tailings may not be filled to the top of the column so that room is provided to feed solvent into the column.

Generally speaking, the loading of tailings into the column as described above will lead to a well packed column. That is to say, the tailings will settle into the vertical column in a manner that results in minimal void spaces within vertical column. If the vertical column is not well packed (i.e., includes too many void spaces or overly large void spaces), solvent added to the column to dissolve and extract bitumen (a step of the method described in greater detail below) will flow through the vertical column too quickly. When solvent passes through the tailings too quickly, an insufficient amount of solvation of bitumen occurs and a generally poor extraction process results.

In some embodiments, additional steps may be taken to ensure a packed column of tailings and thereby promote sufficient solvation of bitumen when solvent is passed through the tailings loaded in the column. In some embodiments, the size of individual pieces of the tailings can be reduced prior to loading the tailings into the column. Reducing the size of the pieces of the tailings may help the pieces of the tailings settle closer to each other in the column and avoid the formation of void spaces or overly large void spaces. The pieces of tailings can be reduced in size by any suitable procedure, such as by crushing or grinding the pieces. In some embodiments, the pieces are reduced in size based on the diameter of the column used. In some embodiments, the pieces are reduced to a size that is 15% or less than the diameter of the column. For example, when the column has a diameter of 40 inches, the pieces can be reduced to a size of 6 inches or less.

In other embodiments, the tailings can be packed down once it is loaded in the column in order to reduce or eliminate void spaces. Any method of packing down the tailings may be used. In some embodiments, a piston or the like is inserted into the top end of the vertical column and force is applied to the piston to move the piston downwardly into the column in order to pack down the tailings. The piston may apply pressure downwardly on the tailings loaded in the column as a consistent application of downward pressure or as a series of downward blows. Alternatively, a vibration device, such as the device disclosed in U.S. Pat. No. 3,061,278 can be used to pack down the tailings. Packing down of the tailings can also be performed manually. Additionally, packing may be allowed to occur under its own weight, including after solvent has been added to the tailings. After solvent has been added to the tailings and the bitumen has become partially solvated, the mixture of solvent and tailings can compact and slump down under its own weight. After the tailings are packed down once, additional tailings can be added to the column to take up the space in the column created by the packing. The packing down of tailings and adding of further tailings can be repeated one or more times.

In step 810, a first quantity of first solvent is fed into the column. One objective of adding first solvent to the column is to dissolve the bitumen content of the tailings loaded in the column. Put another way, the first solvent is added to the column to reduce the viscosity of the bitumen and allow it to flow through and out of the column. Without the first solvent, the bitumen content of the tailings at room temperature may have a viscosity in the range of 100,000 times that of water and will not flow through the column. The addition of the first solvent reduces the viscosity of the bitumen to a flowable state and allows it to travel out of the column with the first solvent.

Accordingly, the first solvent used in step 810 can be any suitable solvent for dissolving or reducing the viscosity of the bitumen in the bitumen material. In some embodiments, the first solvent includes a hydrocarbon solvent. The first solvent can be the same solvent as is used when mixing solvent and bituminous material in the upstream mixing drum. In some embodiments, the solvent is an aromatic solvent or a blend of aromatic and paraffinic solvents.

The first solvent added into the column need not be 100% first solvent. Other components can be included with the first solvent when it is added into the column. In some embodiments, the first solvent added into the column includes a bitumen content. The first solvent might include a bitumen content when the first solvent added into the column in step 810 is solvent that has already been used to extract bitumen. As described in greater detail below, first solvent that passes through tailings in a column may exit the column as bitumen-enriched solvent, and this bitumen-enriched solvent may be used to carry out step 810 being performed on a different column packed with tailings. For example, bitumen-enriched solvent collected from the bottom of a first column as described in greater detail below may be added to bitumen material loaded in a second column in order to carry out step 810 in the second column.

The first solvent can be fed into the column in a wide variety of ways. For example, in some embodiments, first solvent is injected into the tailings loaded in the column at various locations along the height of the column. Such injection may be accomplished through the use of column side injectors that are spaced along the height of the column and extend through the side wall of the column and into the interior of the column where the tailings are loaded. Injection of first solvent at various locations along the height of the column can also be accomplished by using a single pipe that extends down into the column and includes various locations along the length of the pipe where first solvent can exit the pipe. The pipe can be positioned down the center of the column or off to the side of the column.

In configurations such as those described above, the first solvent may be injected into the column beginning with the lowest injection positions first and moving upwardly through the column. Injecting first solvent into the column in this manner and in this order helps to ensure percolation of first solvent through the column and prevents the column from plugging up as described in greater detail below.

In some embodiments, the amount of first solvent added to the column is based on a ratio of first solvent to bitumen content in the tailings on a v/v basis (herein referred to as “S:B”) In some embodiments, the S:B ratio is greater than 1.

As discussed above, the first solvent can be injected into the column starting from the bottom of the column and moving upwards to the top of the column. Injecting the first solvent into the column in this manner may beneficially prevent the column from plugging by ensuring that the S:B ratio does not fall below 1 at any location inside the column. If first solvent is added at the top of the column at an S:B ratio of 1, a portion of the first solvent may flow down the column to a location where the S:B ratio is below 1 and therefore does not sufficiently reduce the viscosity of the bitumen to flow through the column. This may result in the column plugging up. By introducing the first solvent at an S:B ratio of at least 1 at the bottom of the column and subsequently and sequentially adding first solvent at higher positions along the column at an S:B ratio greater than 1, portions of the injected first solvent may not be able to flow downwardly to a location in the column where the S:B ratio is not greater than 1 and plug the column. Accordingly, the manner of injecting the first solvent into the column described in greater detail above may avoid problems related to column plugging.

If the column does become plugged due to the S:B ratio falling below 1 at a location within the column, steps can be taken to unplug the column. More specifically, the location of the plug can be identified and additional first solvent can be injected into the column at the injection point just below the plug (when the column is operated in a downward flow mode). The additional first solvent injected into the column can be injected into the column in such a manner as to close off the bottom of the column and force the first solvent to flow upwardly though the column. For example, increasing the flow rate and pressure of the injected first solvent may result in closing off the bottom of the column. The upwardly moving first solvent may then displace and dissolve the bitumen phase causing the plug due to the viscosity issues.

The first solvent fed into the column flows downwardly through the tailings loaded in the column. The first solvent flows downwardly through the height of the column via small void spaces in the tailings. The first solvent may travel the flow of least resistance through the tailings. As the first solvent flows through the tailings, the first solvent can dissolve bitumen contained in the tailings and thereby form bitumen-enriched solvent. In some embodiments, 90%, preferably 95%, and most preferably 99% or more of the bitumen in the tailings is dissolved in the first solvent and becomes part of the bitumen-enriched solvent phase.

The bitumen-enriched solvent that flows downwardly through the height of the column may exit the column at, for example, the bottom end of the column. As a result, the bitumen-enriched solvent exiting the column can be collected. Any method of collecting the bitumen-enriched solvent can be used, such as by providing a collection vessel at the bottom end of the column. The bottom end of the column can include a metal filter screen having a mesh size that does not permit bitumen material to pass through but which does allow for bitumen-enriched solvent to pass through and collect in a collection vessel located under the screen. Collection of bitumen-enriched solvent can be carried out for any suitable period of time. In some embodiments, collection is carried until the bitumen-enriched solvent phase substantially or completely stops exiting the column. In some embodiments, collection is carried out for from 2 to 60 minutes.

In some embodiments, the bitumen-enriched solvent collected contains from about 10 wt % to about 60 wt % bitumen and from about 40 wt % to about 90 wt % first solvent. Minor amounts of non-bitumen material can also be included in the bitumen-enriched solvent phase.

In some embodiments, the flow of solvent through the column and the removal of bitumen-enriched solvent phase are aided by adding a pressurized gas into the column either before or after solvent is fed into the column. Applying a pressurized gas over the tailings loaded in the column can facilitate the separation of the bitumen-enriched solvent from the non-bitumen components of the tailings loaded in the vertical column. Once liberated and having a much reduced viscosity due to the addition of the solvent, the bitumen-enriched solvent phase can be pushed out of the column either by the continual addition of pressurized gas or by feeding additional solvent into the column. The addition of additional solvent or bitumen-enriched solvent collected can displace the liberated bitumen-enriched solvent from the tailings by providing a driving force across a filtration element (i.e., the non-bituminous components of the tailings). Any suitable gas may be used. In some embodiments, the gas is nitrogen, carbon dioxide or steam. The gas can also be added over the tailings loaded in the vertical column in any suitable amount. In some embodiments, 1.8 m³ to 10.6 m³ of gas per ton of tailings is used. This is equivalent to a range of about 4.5 liters to 27 liters of gas per liter of tailings. In certain embodiments, 3.5 m³ of gas per ton of tailings is used.

After collecting bitumen-enriched solvent, the collected bitumen-enriched solvent can optionally be fed back into the column for another pass through the tailings packed in the column. The bitumen-enriched solvent phase can be fed into the column in a similar or identical manner as described above with respect to feeding a first quantity of solvent into the column. The bitumen-enriched solvent may be fed back into the column “as is” or may be diluted with additional first solvent prior to feeding the bitumen-enriched solvent back into the column. The amount of bitumen-enriched solvent phase fed into the column is not limited. In some embodiments, the bitumen-enriched solvent fed into the column is approximately 0.5 to 4.0 times the amount of bitumen by volume contained in the original bitumen material.

In some embodiments, the bitumen-enriched solvent fed into the column behaves much like the first quantity of first solvent fed into the column. The bitumen-enriched solvent flows downwardly through the column, dissolving additional bitumen still contained in the column and forcing any entrapped bitumen-enriched solvent out of the column. The bitumen-enriched solvent eventually may exit the column, where it may be collected.

The steps of collecting bitumen-enriched solvent and feeding bitumen-enriched solvent back into the column can be repeated one or more times in order to remove greater amounts of bitumen from the tailings loaded in the column. In some examples, the steps of collecting the bitumen-enriched solvent and feeding the bitumen-enriched solvent into the column are repeated until less than 1 wt % bitumen of the bitumen material is remaining in the column.

In some embodiments, more than one column is provided for carrying out the extraction of bitumen from tailings. The columns can generally be aligned in parallel and can each receive a portion of the tailings produced in the mixing drums upstream. The bitumen-enriched solvent produced from each of the columns can be combined for further use or processing. Similarly, the tailings leaving each of the columns after bitumen extraction can be combined for further processing or disposal.

In some embodiments, the bitumen-enriched solvent obtained from processing the tailings in the columns can be used as the solvent that is sprayed over bituminous material in the upstream mixing drums. Alternatively, the bitumen-enriched solvent can be separated into a solvent phase and a bitumen phase. The bitumen-enriched solvent can also be divided such that some of the bitumen-enriched solvent is used upstream in the mixing drums, and a remaining portion is separated into solvent and bitumen.

In some embodiments, the tailings remaining in the column after solvent has been passed therethrough contain a trace amount first solvent. Accordingly, further drying steps can be carried out in order to remove and recover the trace amount of first solvent. Any suitable drying apparatus can be used. The drying apparatus generally operates by heating the tailings to the point of evaporating the first solvent. The evaporated first solvent can be collected, condensed, and reused. The dried tailings can be disposed of.

Alternatively, the trace amount of first solvent in the tailings can be removed from the tailings by performing a step 820 of feeding a second solvent into the tailings. The second solvent displaces the first solvent from tailings and a mixture of first solvent and second solvent exits the column. In some embodiments, the first solvent, the second solvent, or both solvents may include dissolved bitumen.

The amount and manner of feeding second solvent into the column can be similar or identical to the manner in which the first solvent is fed into the column. The mixture of second solvent and first solvent that exits the column can be collected and re-introduced into the column in a similar or identical manner to how the bitunen-enriched solvent is collected and fed back into the column. Once the second solvent has been passed through the column a desired number of times, the mixture of first solvent and second solvent can be processed in order to separate the first solvent from the second solvent and to remove any bitumen content contained in the first and second solvents.

The second solvent can be any solvent capable of displacing first solvent from the tailings. In some embodiments, the second solvent is a paraffinic solvent, such as pentane. In some embodiments, the second solvent is a polar solvent, such as methanol, ethanol, propanol, and butanol. In some embodiments, the second solvent has a lower boiling point temperature than the first solvent.

After passing second solvent through the tailings, the tailings can be discharged from the packed column and subjected to drying steps to remove any trace amount of second solvent contained in the tailings. Removal of solvent from the tailings can be carried out in any suitable manner, including through the use of a dryer. The dryer can warm the tailings to evaporate the second solvent from the tailings. The evaporated second solvent can be collected, condensed and reused. When the second solvent has a boiling point temperature lower than the first solvent, the removal of the second solvent from the tailings by drying is less energy intensive and more economical then when a dryer is used to remove first solvent from the tailings.

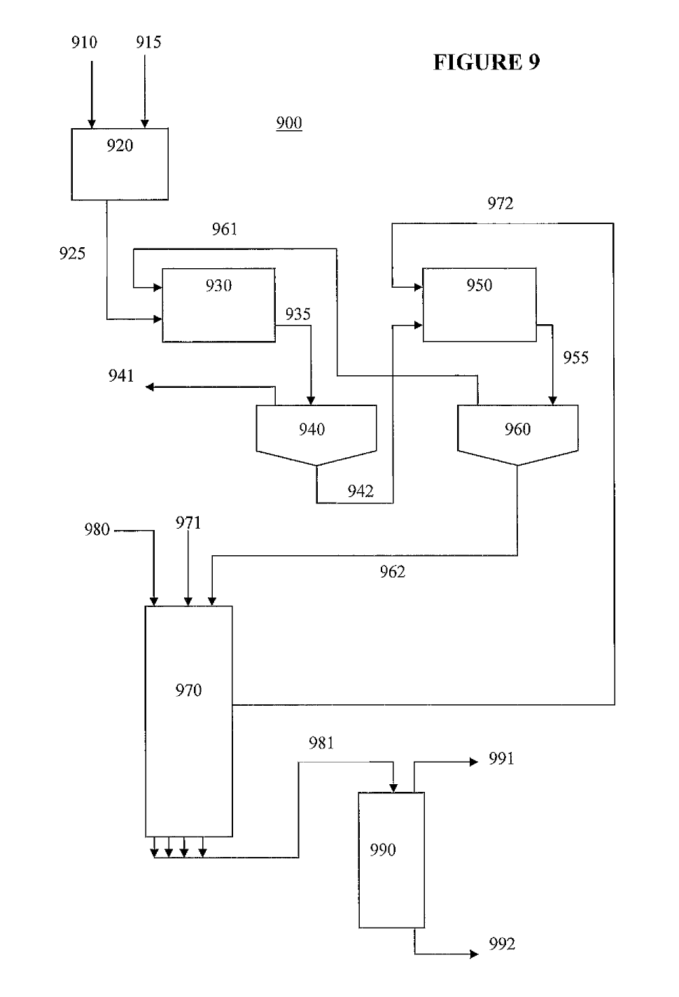

With reference to FIG. 9, a system 900 including packed columns downstream of the mixing drums is illustrated. The system 900 generally includes a mineral sizer 920, a first pulper 930, a first thickener 940, a second pulper 950, a second thickener 960, a wash column 970, and a dryer 990. While the system 900 includes, for example, two pulpers, other embodiments of the system can have fewer or more pulpers. The system 900 will generally include one thickener paired with each pulper. The system 900 can also include multiple wash columns. In some embodiments, the system 900 includes four wash columns aligned in parallel.

In operation, system 900 begins with bituminous material 910, such as the bituminous material described above, being transported into the mineral sizer 920. First solvent 915, such as an aromatic solvent, can be injected into the mineral sizer 920 at the same time as the bituminous material 910 (as shown in FIG. 9) and/or can be mixed with the bituminous material 910 prior to its introduction into the mineral sizer 920. The mineral sizer 920 works to reduce the size of large clumps of material that may be present in the bituminous material 910, and the first solvent 915 helps to begin the process of dissolving bitumen while reducing the wear on the mineral sizer.

A slurry 925 of bituminous material and first solvent exits the mineral sizer 920 and is transported to the first pulper 930. In the first pulper 930, first solvent is sprayed over the slurry 925 as described in greater detail above. The first solvent sprayed over the slurry 925 in the pulper 930 can be a fresh stream of first solvent, or, as shown in FIG. 9, or can be recycle disbit 961 obtained from the downstream second thickener 960. In some embodiments, the first solvent used in the first pulper 930 is the same solvent used in the mineral sizer 915 and as will be used in the second pulper 950. When disbit 961 is used, the solvent component of the dilbit can be same first solvent used in other parts of the system 900.

A first pulper slurry 935 is produced as a result of the mixing of first solvent and bituminous material in the first pulper 930. In some embodiments, separation of the first pulper slurry 935 into a disbit stream and a bitumen-depleted slurry call be carried out inside of the pulper. However, as shown in FIG. 9, the first pulper slurry 935 leaves the first pulper 930 and is transported to a first thickener 940. The first thickener 940 operates to separate the first pulper slurry 935 into a disbit stream 941 and a bitumen-depleted slurry stream 942. The disbit stream 941 can be sent to further processing apparatus where the solvent component of the disbit stream 941 is separated from the bitumen component. The bitumen-depleted slurry stream 942 is transported to a second pulper 950.

The second pulper 950 operates in much the same way as the first pulper 930. First solvent is sprayed over the bitumen-depleted slurry stream 942 in order to dissolvent additional bitumen content. The first solvent can be clean first solvent, or, ash shown in FIG. 9, can be disbit 972 obtained from the downstream wash column 970.

A second pulper slurry 955 is produced as a result of the mixing of first solvent and bitumen-depleted slurry in the second pulper 950. In some embodiments, separation of the second pulper slurry 955 into a disbit stream and a bitumen-depleted slurry can be carried out inside of the pulper. However, as shown in FIG. 9, the second pulper slurry 955 leaves the second pulper 950 and is transported to a second thickener 960. The second thickener 960 operates to separate the second pulper slurry 955 into a disbit stream 961 and a bitumen-depleted slurry stream 962. The disbit stream 961 can be sent to further processing apparatus where the solvent component of the disbit stream 941 is separated from the bitumen component, or can be recycled back for use in the first pulper 930. The bitumen-depleted slurry stream 962 is transported to one or more downstream wash columns 970.

The bitumen depleted slurry stream 962 is loaded in the one or more wash columns 970, where first solvent 971 is passed through the bitumen-depleted slurry stream 962 in order to dissolve additional bitumen and remove the bitumen from the bitumen-depleted slurry stream 962 in the form of a disbit stream 972. The first solvent 971 used in the wash column 972 can be the same first solvent used in other portions of the system 900. In some embodiments, multiple wash cycles are carried out and can include recycling disbit 972 back through the wash column 970. Once a sufficient number of wash cycles have been carried out, the disbit 972 can be sent to separation apparatus for separating first solvent from bitumen, or, as shown in FIG. 9, can be recycled back for use in the second pulper 950.

The solvent washing that takes place in the wash column 970 ultimately produces a solvent-wet tailings phase 973. Second solvent 980, such as the second solvent described in greater detail above, can be passed through the wash column in order to wash the first solvent from the tailings. A mixture of first solvent and second solvent (not shown) can be passed collected at the bottom end of the wash column 970 and be passed back through the column 970 in order to displace additional first solvent. This can be repeated any number of times until a suitable amount of first solvent has been removed from the tailings. At that point, the mixture of first solvent and second solvent can be sent to separation apparatus to separate the first solvent from the second solvent (such as by virtue of their different boiling points) and additional steps can be taken to remove any bitumen from the first and second solvent.

The tailings remaining in the wash column 970 can have trace amounts of second solvent contained therein. Accordingly, the tailings 981 can be removed from the wash column 970 and be sent to a dryer 990 for removing second solvent from the tailings. In some embodiments, the dryer 990 can operate by heating the tailings phase 981 to a temperature above the boiling point temperature of the second solvent component, thereby causing the second solvent to evaporate and exit the dryer 990 as a second solvent vapor 991. The second solvent vapor 991 can then be sent to a condenser for condensing the vapor back to a liquid so that it might be reused in the system 900. Once the second solvent has been evaporated from the tailings, a dry tailings phase 992 can be discharged from the dryer and disposed of.

### EXAMPLES

### 1. Single Mixing Drum Configuration (Percentage Values in Mass %)

160 kg/hr of Athabasca oil sands having 84% sand, 11% bitumen, and 5% water content is fed into a mixing drum having an aspect ratio of 1.7 and including a liner screen for separating a slurry produced inside of the mixing drum. Solvent in the form of disbit is sprayed over the oil sand in the mixing drum as the mixing drum rotates at a speed of 2 rpm. The disbit is sprayed over the oil sands at a rate of 52.5 kg/hr. The disbit includes 30.4% bitumen, 0.2% water, and 68.4% Aromatic 150 and has a S:B ratio of 2.25. The disbit and the oil sand mix in the rotating mixing drum for a period of 10 minutes.

The screen liner in the mixing drum separates the slurry into disbit and tailings. The disbit is sent to a decanter to remove solid particles from the disbit. The decanted disbit is produced at a rate of 36.5 kg/hr and includes 47% bitumen, 0.25% water, and 51.75% Aromatic 150. The solids decanted from the disbit are combined with the tailings leaving the mixing drum. The tailings leave the mixing drum at a rate of 176 kg/hr and include 76.4% sand, 9.3% bitumen, 4.5% water, and 9.8% Aromatic 150.

The bitumen extraction efficiency is calculated to be 51% based on the amount of bitumen entering into the mixing drum in the form of oil sands and the amount of bitumen in the disbit collected after the disbit leaves the decanter.

### 2. Multiple Mixing Drum Configuration

The tailings produced from the mixing drum in Example 1 are transported into a second mixing drum having an aspect ratio of 1.7 and rotating at a speed of 2 rpm. Fresh Aromatic 150 is sprayed over the tailings in the second mixing drum at a rate of 37 kg/hr. The tailings and Aromatic 150 mix in the rotating mixing drum for a period of 10 minutes. A screen liner inside the second mixing drum separates the slurry into a second tailings stream and second disbit stream. The second disbit stream is sent to a decanter to remove solid particles from the disbit. The resulting second disbit stream is produced at a rate of 38 kg/hr and includes 23% bitumen, 1% water, and 76% Aromatic 150. The decanted second disbit stream is transported to the first mixing drum where it is sprayed over a further quantity of oil sands. The further quantity of oil sands has the same composition as the oil sands described in Example 1 and is introduced into the first mixing drum at a rate of 160 kg/hr. The second disbit stream is sprayed over the further quantity of oil sands at a rate of 38 kg/hr. The screen liner in the first mixing drum separates the slurry into a third disbit stream and a third tailings stream. The third disbit stream is produced at a rate of 36.5 kg/hr and the third tailings stream is produced at a rate of 176 kg/hr. The third disbit stream includes 48% bitumen, 0.25% water, and 51.75% Aromatic 150. The third tailings stream includes 83% sand, 5.6% bitumen, 6.2% Aromatic 150 and 4.9% water.

The bitumen extraction rate in Example 2 is an improvement over the bitumen extraction rate achieved in Example 1 due to the countercurrent flow of the disbit produced in each mixing drum. The bitumen extraction efficiency is calculated at 75%.

### 3. Mixing Drum and Single Hydrocyclone Configuration

The slurry produced in the mixing drum in Example 1 is not separated by a screen liner, and exits the mixing drum. The slurry is pumped to a thickener and the solids and liquid are allowed to separate by gravity. The thickener overflow is product disbit having a bitumen content of 45% and Aromatic 150 content of 55%. The thickener underflow is discharged at a rate of 22.5 t/hr and is diluted with 4.5 t/hr of fresh Aromatic 150 solvent and pumped to and injected into a KREBS D6BGMAX hydrocyclone having a 6″ diameter. The hydrocyclone operates to separate the slurry into a first disbit stream that leaves the hydrocyclone from the overflow and a tailings stream that leaves the hydrocyclone from the underflow. The first disbit stream leaves the hydrocyclone at a rate of 7.1 t/hr and includes 20.8% bitumen, 53.2% aromatic solvent, and 0.25% water. The tailings stream leaves the hydrocyclone at a rate of 19.9 t/hr and includes 70% sand, 7.0% bitumen, 5.0% water, and 18% Aromatic 150 solvent.

The bitumen extraction rate is calculated at 89.8% based on the amount of bitumen entering into the mixing drum in the form of oil sands and the amount of bitumen in the disbit collected from the overflow of the hydrocyclone.

4. Single Mixing Drum with Multiple Hydrocyclones Configuration

The tailings leaving the thickener in Example 3 is transported to and injected into a hydrocyclone as in Example 3, except the fresh disbit added to the thickener underflow in that example is replaced by the second hydrocyclone disbit overflow in this the multiple hydrocyclone circuit. The slurry produced in the thickener exits the mixing drum at a rate of 22.5 t/hr. The slurry is diluted with 12.8 t/hr of disbit second cyclone overflow and pumped to and injected into a hydrocyclone having 6″ diameter. The hydrocyclone operates to separate the slurry into a first disbit stream that leaves the hydrocyclone from the overflow and a tailings stream that leaves the hydrocyclone from the underflow. The first disbit stream leaves the hydrocyclone at a rate of 14.1 t/hr and includes 19.2% bitumen, 63.5% Aromatic 150 solvent, and 0.25% water. The tailings stream leaves the hydrocyclone at a rate of 21.1 t/hr and includes 70% sand, 5.9% bitumen, 4.8% water, and 19.4% Aromatic 150 solvent.

Prior to being injected into the second hydrocyclone, the tailings are mixed with disbit from a third hydrocyclone overflow at a rate of 11.9 t/hr. The resulting slurry is fed into the second hydrocyclone at a rate of 34.1 t/hr. The second hydrocyclone is a KREBS D6BGMAX hydrocyclone having a 6″ diameter. The second hydrocyclone separates the slurry into a second disbit stream and a second tailings stream. The second disbit stream is produced at a rate of 12.8 t/hr and includes 8.5% bitumen, 79.7% Aromatic 150 solvent, and 0.25% water. The second tailings are produced at a rate of 20.3 t/hr and includes 70% sand, 2.3% bitumen, 4.8% water, and 21.7% Aromatic 150 solvent.

The second disbit stream is transported back to be mixed with a further quantity of bitumen depleted oil sands from the thickener underflow.

The bitumen extraction rate in Example 4 is an improvement over the bitumen extraction rate achieved in Example 3 due to the countercurrent flow of the disbit produced in each hydrocyclone. The bitumen extraction rate is calculated at 94.1%. Further hydrocyclones can be added to wash and remove additional bitumen if required, leaving a solvent wet tailings which can be heated to evaporate and recover the solvent, to leave a ‘dry stackable’ tailings.

5. Second Series of Hydrocyclones for Removal of Solvent from Tailings

The third tailings leaving the second hydrocyclone in Example 4 are transported to and injected into a first hydrocyclone in a second series of hydrocyclones. Prior to injection into the first hydrocyclone, the tailings are mixed with a mixture of pentane solvent and Aromatic 150 solvent with some residual bitumen produced from a second hydrocyclone in the second series of hydrocyclones. The solvent mixture is added to the tailings at a rate of 10.7 t/hr. The resulting slurry is injected into a first KREBS D6BGMAX hydrocyclone having a 6″ diameter. The first hydrocyclone separates the slurry into an overflow solvent mixture of Aromatic A150 solvent and pentane and an underflow tailings stream. The solvent mixture is produced at a rate of 11.9 t/hr and includes 29% Aromatic 150 and 71% pentane The solvent mixture is sent to a distillation tower to separate the solvents.

The tailings produced by the first hydrocyclone include 72% sand, 7% Aromatic 150, 16% pentane, and 4.6% water. The tailings are mixed with pentane at a rate of 11.9 t/hr to produce a slurry. The slurry is injected into a second KREBS D6BGMAX hydrocyclone having a 6″ diameter. The second hydrocyclone operates to separate the slurry into an overflow mixture of Aromatic 150 and pentane and an underflow tailings stream. The solvent mixture is produced at a rate of 11.8 t/hr and includes 9% Aromatic 150 and 91% pentane This solvent mixture is transported back to be mixed with the tailings entering the first hydrocyclone in the second series as discussed above. The tailings include 70% sand, 1% Aromatic 150, 20% pentane, and 4.6% water. In this manner, Aromatic 150 solvent is effectively removed from the tailings produced at the end of the first series of hydrocyclones. Further hydrocyclones can be added to wash and remove additional Aromatic 150 if required, leaving a pentane wet tailings which can be heated to evaporate and recover the pentane, to leave a ‘dry stackable’ tailings.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

What is claimed is:

1. A bitumen extraction method comprising:
feeding a first quantity of bituminous material into a mixing drum;
spraying first solvent over the first quantity of bituminous material inside the mixing drum and creating a slurry;
separating coarse solids from the slurry and removing the slurry from the mixing drum;
separating the slurry into a first disbit stream and a first tailings stream;
feeding the first tailings stream into the mixing drum;
spraying second solvent over the first tailings stream inside the mixing drum;
removing the first tailings stream from the mixing drum; and
separating the first tailings stream into a second disbit stream and a second tailings stream.

2. The method as recited in claim 1, further comprising:
feeding a second quantity of bituminous material into the mixing drum; and
spraying the second disbit stream over the second quantity of bituminous material inside the mixing drum.

3. The method as recited in claim 1, further comprising transporting the first disbit stream to a disbit storage unit.

4. The method as recited in claim 2, wherein the first quantity of bituminous material and the second quantity of bituminous material comprise oil sands.

5. The method as recited in claim 2, further comprising:
rotating the mixing drum while spraying first solvent over the first quantity of bituminous material;
rotating the mixing drum while spraying second solvent over the first tailings; and
rotating the mixing drum while spraying the second disbit stream over the second quantity of bituminous material.

6. The method as recited in claim 5, wherein the mixing drum is operated at least 30% of the critical rotational speed.

7. The method as recited in claim 1, wherein the first disbit stream comprises from 40% to 50% solvent by volume.

8. The method as recited in claim 1, wherein separating coarse solids from the slurry comprises filtering the slurry through a screen liner inside of the mixing drum.

9. The method as recited in claim 1, wherein separating the first tailings into a second disbit stream and a second tailings stream comprises filtering the first tailings.

10. The method as recited in claim 3, further comprising:
separating solid material from the first disbit stream prior to transporting the first disbit stream to the disbit storage unit

11. The method as recited in claim 2, further comprising:
separating solid material from the second disbit stream prior to spraying the second disbit stream over the second quantity of bituminous material.

12. The method as recited in claim 10, wherein separating solid material from the first disbit stream comprises subjecting the first disbit stream to a hydrocyclone or centrifugal separation unit

13. The method as recited in claim 11, wherein separating solid material from the second disbit stream comprises subjecting the second disbit stream to a hydrocyclone or centrifugal separation unit.

14. The method as recited in claim 2, further comprising adding solvent to the second disbit stream or removing bitumen from the second disbit stream prior to spraying the second disbit stream over the second quantity of solid material.

15. The method as recited in claim 1, wherein the first solvent sprayed over the first quantity of bituminous material comprises an aromatic solvent, a paraffinic solvent, or a mixture thereof.

16. The method as recited in claim 1, wherein the second solvent sprayed over the first tailings stream inside the second mixing drum comprises disbit.

17. The method as recited in claim 1, wherein the first quantity of bituminous material is deoxygenated prior to feeding the first quantity of bituminous material into the mixing drum.

18. The method as recited in claim 1, wherein the first quantity of bituminous material is screened prior to feeding the first quantity of bituminous material into the mixing drum.

19. A bitumen extraction method comprising:
feeding a first quantity of bituminous material into a first mixing drum;
spraying first solvent over the first quantity of bituminous material inside the first mixing drum;
separating the first quantity of bituminous material into a first disbit stream and a first tailings stream;
feeding the first tailings stream into a second mixing drum;
spraying second solvent over the first tailings stream inside the second mixing drum; and
separating the first tailings stream into a second disbit stream and a second tailings stream.

20. The method as recited in claim 19, further comprising:
feeding a second quantity of bituminous material into the first mixing drum; and
spraying the second disbit stream over the second quantity of bituminous material inside the first mixing drum.

21. The method as recited in claim 19, further comprising transporting the first disbit stream to a disbit storage unit.

22. The method as recited in claim 20, wherein the first quantity of bituminous material and the second quantity of bituminous material comprise oil sands.

23. The method as recited in claim 20, further comprising:
rotating the first mixing drum while spraying first solvent over the first quantity of bituminous material;
rotating the second mixing drum while spraying second solvent over the first tailings; and
rotating the first mixing drum while spraying the second disbit stream over the second quantity of bituminous material.

24. The method as recited in claim 23, wherein the first mixing drum and the second mixing drum are operated at least 30% of the critical rotational speed.

25. The method as recited in claim 19, wherein the first disbit stream comprises from 40% to 50% solvent by volume.

26. The method as recited in claim 19, wherein separating the first quantity of bituminous material into a first disbit stream and a first tailings stream comprises filtering the first disbit stream from the first tailings stream through a screen liner positioned inside of the first mixing drum.

27. The method as recited in claim 19, wherein separating the first tailings into a second disbit stream and a second tailings stream comprises filtering the second disbit stream from the second tailings stream through a screen liner positioned inside of the first mixing drum.

28. The method as recited in claim 21, further comprising:
separating solid material from the first disbit stream prior to transporting the first disbit stream to the disbit storage unit

29. The method as recited in claim 20, further comprising:
separating solid material from the second disbit stream prior to spraying the second disbit stream over the second quantity of bituminous material.

30. The method as recited in claim 28, wherein separating solid material from the first disbit stream comprises subjecting the first disbit stream to a hydrocyclone or centrifugal separation unit

31. The method as recited in claim 29, wherein separating solid material from the second disbit stream comprises subjecting the second disbit stream to a hydrocyclone or centrifugal separation unit.

32. The method as recited in claim 20, further comprising adding solvent to the second disbit stream or removing bitumen from the second disbit stream prior to spraying the second disbit stream over the second quantity of solid material.

33. The method as recited in claim 21, wherein the first solvent sprayed over the first quantity of bituminous material comprises an aromatic solvent.

34. The method as recited in claim 19, wherein the second solvent sprayed over the first tailings stream inside the second mixing drum comprises disbit.

35. The method as recited in claim 19, wherein the first quantity of bituminous material is deoxygenated prior to feeding the first quantity of bituminous material into the mixing drum.

36. The method as recited in claim 19, wherein the first quantity of bituminous material is screened prior to feeding the first quantity of bituminous material into the mixing drum.

37. A bitumen extraction system comprising:
a first mixing drum comprising a first solvent inlet, a first disbit outlet, and a first tailings outlet;
a first separation unit comprising a second disbit inlet in fluid communication with the first disbit outlet of the first mixing drum, a cleaned disbit outlet, and a solid materials outlet; and
a second mixing drum comprising a first tailings inlet in fluid communication with the first tailings outlet of the first mixing drum, a second disbit outlet in fluid communication with the first solvent inlet of the first mixing drum, and a second tailings outlet.

38. The bitumen extraction system as recited in claim 37, wherein the first mixing drum comprises a screen liner within the first mixing drum and having a first area within the screen liner and a second area between the screen liner and the first mixing drum, and wherein the first tailings outlet is within the first area and the first disbit outlet is within the second area.

39. The bitumen extraction system as recited in claim 37, wherein the second mixing drum comprises a screen liner within the second mixing drum and having a third area within the screen liner and a fourth area between the screen liner and the second mixing drum, and wherein the second tailings outlet is within the third area and the second disbit outlet is within the fourth area.
